(19) United States
(12) Patent Application Publication
(10) Pub. No.: US 2006/0059419 A1
(43) Pub. Date: Mar. 16, 2006

(54) Cube method of film notation

(76) Inventor: Ronald V. Santicola, Lanesville, NY (US)

Correspondence Address: Ronald V. Santicola, 2101 Route 214, Lanesville, NY, 12450, US

(21) Appl. No.: 10/939,720

(22) Filed: Sep. 13, 2004

(51) Int. Cl. G06F 7/00; G06F 17/24

(52) U.S. Cl. 715/512; 707/102; 707/104.1

(57) ABSTRACT

A system of motion picture notation uses standard data entry characters for symbols and formation, standard words for distinctive formations and distinctive placements, and standard word usage for distinctive placements—all to compose in a script the visual notes and audio notes that represent the cinguistic elements in any motion picture.

### BACKGROUND OF THE INVENTION

This invention relates to a method for composing a notated script for any motion picture.

A common conventional technique for writing motion picture scripts adapts the approach for writing stage plays, interspersing descriptive detail with dialogue. However, this conventional technique affords the creator of original filmic concepts no systemic means for recording the unique filmic aspects of those concepts while he or she is in the effective artistic mood of creation.

Another common technique for writing motion picture scripts adapts the stage-play approach to what is called a shooting script. This conventional technique affords a systemic means of facilitating the production of a motion picture, detailing the laying out of sets and the positioning and movement of cameras. However, it, too, affords the creator of original filmic concepts no systemic means of recording the unique filmic aspects of those concepts while he or she is in the effective artistic mood of creation.

Still another common technique for creating motion picture scripts adapts the stage-play approach to what is called a story board. This conventional technique does afford the creator of original filmic concepts a means for recording the unique filmic aspects of those concepts while he or she is in the effective artistic mood of creation. However, the means employed, composing pictures in still presentations, requires in each instance of such picture composition a unique artistic creation in a media distinct from motion pictures themselves, thus distracting the film creator from his or her effective mood of filmic creation. In addition, the story board approach affords no systemic means of recording the unique filmic aspects of filmic concepts.

Yet another technique for creating motion picture scripts employs computer capabilities to create story boards or, even, actual motion picture evolutions of story boards—in which, for example, the depicted characters actually move. This technique also affords a means of recording filmic concepts, but this means is consistent with the story board approach, similarly functioning as a unique creation for each motion picture script, or motion picture, and affording no systemic ingredients regarding filmic concepts from one motion picture script to another.

Thus, all of the conventional techniques for creating motion picture scripts lack a systemic approach for recording, or notating, filmic concepts. In other words, they fail to function for motion picture conception and recording in the manner, for example, that music notation functions for the composition of music or that dance notation functions for the composition of dance.

This deficiency in the conventional methods of writing motion picture scripts cripples the creation of motion pictures at their most acute phase, when the author of an original filmic conception needs to record the thread of his or her thought in a comprehensive filmic manner.

### SUMMARY OF THE INVENTION

In view of the absence of a true notation method in the foregoing mentioned conventional techniques for writing motion picture scripts, it is the object of the present invention to provide a method of motion picture (or film) notation that affords a comprehensive recording of filmic concepts.

The first task in this objective is to identify such a notation method's place in communication, which requires a starting point where reality itself is defined.

Reality is that which actually occurs. It includes physical and metaphysical occurrences. It is actualized through the phenomenon of being. It is identifiable through its significant effects, with such effects existing inseparably from, and simultaneously signifying, that which occurs. (For example, the effects of an oak tree are its particular roots, trunk, branches, and leaves; and these, its significant effects, are what signify it as an oak tree.)

Through the phenomenon of perception, the mind perceives reality's significant effects. It perceives the significant effects of physical reality through the body and of metaphysical reality through the soul.

Through the phenomenon of conception, which functions jointly with the phenomenon of perception, the mind, acting upon what it perceives to be reality's significant effects, conceives thought. Through this joint process of perception and conception, thought assimilates reality's significant effects as its own. The resulting significant effects in thought may or may not correlate with reality's significant effects, depending on the accuracy of the perception and the accuracy of the conception. Nonetheless, attendant to reality are significant effects and attendant to thought are significant effects proffering to correlate with reality's significant effects.

Also attendant to thought is the phenomenon of meaning. Thought's containment of significant effects coincides with its containment of meaning such that the statement, “it (thought) has meaning,” can accurately be interchanged with the statement, “it (thought) has a significant effect.”

Attendant to meaning are the phenomena of nomination and predication. Nomination identifies person, place, or thing (including idea) in meaning. Predication identifies the state (including action and condition) of the nomination in the meaning.

Attendant to nomination and predication are the phenomena of essence and presence. Essence is the universality in the nomination and predication, that which makes a nomination and a predication applicable to more than one meaning. Presence is the individuality in the nomination and predication, that which makes a nomination and a predication applicable to a specific meaning.

Attendant to essence and presence is the phenomenon of extension. Although it is the universality in the essence that makes the extension possible, the essence coincides with the presence and, therefore, is inseparable from it in the phenomenon of extension.

The phenomenon of extension occurs within the mind when the mind reasons and remembers regarding the meaning contained in thought. The extension occurs outside the mind when the mind communicates the thought through the phenomenon of media.

Communication, or the extending of thought through media, always involves the synchronization of thought and media, with thought, as already explained, having attendant to it meaning and meaning having attendant to it nomination and predication and these having attendant to them essence and presence, which are what make extension possible.

In addition, attendant to the extension of thought through media are two other phenomena: the storage of thought and the reception of thought. These three phenomena, the extending, storing, and receiving of thought, form the tricom. Each phenomenon in the tricom occurs with distinct manifestation, although often imperceptibly so. (For example, thought may be extended in a book that is stored for centuries and then received through an act of reading; or thought may be extended through speech that is stored for an imperceptible moment in sound waves and received through an act of hearing that appears to be simultaneous to the speech but in infinitesimal measurement actually is not.)

The manifestation of the tricom and all that it contains, reaching back to reality's significant effects, is represented by the term inguistics, which term also represents the science of this manifestation. (In this vein, linguistics is a part of inguistics.)

Inguistics as it applies to the media film is represented by the term cinguistics.

Within the context of the foregoing discussion about communication, the media film consists of a presentation in which thought, with its attendant significant effects, is extended through a synchronization of visual content and audio content. Therefore, it is within these two types of content that the cinguistic elements of film, and thereby filmic thought, exist. To script these cinguistic elements with completeness requires a method for representing them with completeness.

The present invention's characteristic of completeness is made possible because it has features for scripting all the significant effects in filmic thought. These effects culminate into a totality that represents the whole of a given motion picture. The whole motion picture, however, results from a combination of the significant effects contained in sequences. The sequences contain these significant effects through visual and audio content in which the cinguistic elements within the significant effects making up the filmic thought are represented. The present invention treats this visual content as visual notes and this audio content as audio notes. Thus, the systemic objective of the visual notes and the audio notes is to represent that which advances meaning.

An object of the present invention is to provide a method of notating motion picture scripts so that the author of an original filmic conception can record it with cinguistic comprehensiveness regardless of the medium used for said recording, whether it be pen and paper, typewriter, or automated word processing.

Briefly stated, a system of motion picture notation uses standard data entry characters for symbols and formations, standard words for distinctive formations and distinctive placements, and standard word usage for distinctive placements—all to compose in a script the visual notes and audio notes that represent the cinguistic elements in any motion picture.

A central feature of the present invention is that persons or objects appearing on a motion picture screen are treated in the script with the assumption that the persons or objects are enveloped in an imaginary three-dimensional form (i.e., a cube or noncubical rectangular box).

### BRIEF DESCRIPTION OF THE DRAWINGS

The foregoing and other objects, aspects, and advantages will be better understood from the following detailed description of a preferred embodiment of the invention with reference to the drawings, in which (with all referring to the present invention):

FIG. 1 shows the vertical bar that identifies visual notes;

FIG. 2A illustrates the filmic coordinates;

FIG. 2B shows a sample application of a filmic coordinate;

FIG. 3A shows a filmic staff;

FIG. 3B shows a sample of a simplified filmic staff;

FIG. 4 shows a sample of a focal place;

FIG. 5 shows a sample of a designator;

FIG. 6A illustrates the portion indicators;

FIG. 6B shows a sample application of a portion indicator;

FIG. 7A illustrates the angle reference symbols;

FIG. 7B illustrates the interpretation of the angle reference symbols;

FIG. 7C illustrates the interpretation of additional angle reference symbols;

FIG. 7D shows a sample application of the angle reference symbols;

FIG. 8A shows a sample application for one plane reference;

FIG. 8B shows a sample application for two or more plane references;

FIG. 8C shows a sample application of the limit of a plane reference;

FIG. 8D shows a sample application of a vertical limiter;

FIG. 8E shows a sample application of a horizontal limiter for one side;

FIG. 8F shows a sample application of a horizontal limiter for two sides;

FIG. 8G shows a sample application of a noncubical plane reference;

FIG. 8H shows a sample application of a cubical plane reference plus a noncubical plane reference;

FIG. 8I shows a sample application of a top marker;

FIG. 8J shows a sample application of an inverted top;

FIG. 9A illustrates the depth reference symbols;

FIG. 9B shows a sample application of the depth reference symbols;

FIG. 9C shows a sample application of a same plane reference with a different depth reference;

FIG. 9D shows a sample application of a same plane reference with the same depth reference;

FIG. 9E shows a sample application of multiple depth references;

FIG. 9F shows a sample application of a noncubical plane reference with different depth references;

FIG. 9G shows a sample application of a curved noncubical reference;

FIG. 10 shows a sample application of an abridgement of the filmic aspects;

FIG. 11A shows a sample application of contained aspects of focal designation;

FIG. 11B shows a sample application of contained descriptive detail extension;

FIG. 12 shows a sample application of a concluding filmic coordinate and a time indicator;

FIG. 13 shows a sample application of an end bar;

FIG. 14 shows a sample application of focal modifiers;

FIG. 15 shows a sample application of an assumed focal designator;

FIG. 16A shows a sample application of a first embodiment of continuity in visual notes;

FIG. 16B shows a sample application of a second embodiment of continuity in visual notes;

FIG. 16C shows a sample application of a third embodiment of continuity in visual notes;

FIG. 16D shows a sample application of a fourth embodiment of continuity in visual notes;

FIG. 16E shows a sample application of a fifth embodiment of continuity in visual notes;

FIG. 17 shows a sample application of dialogue;

FIG. 18A shows a sample application of intrinsic narration;

FIG. 18B shows a sample application of extrinsic narration;

FIG. 19A shows a sample application of intrinsic sound effects;

FIG. 19B shows a sample application of extrinsic sound effects;

FIG. 20A shows a sample application of intrinsic music;

FIG. 20B shows a sample application of extrinsic music;

FIG. 21 shows a sample application of continuity in audio notes;

FIG. 22A shows a sample application of a glimmer with other focal designations;

FIG. 22B shows a sample application of a glimmer substituting for several focal designations;

FIG. 22C shows a sample application of a glimmer alone;

FIG. 23A shows a sample application of a focal designation as a framer framing the top of a focal enclosure;

FIG. 23B shows a sample application of a focal designation as a framer framing the bottom of a focal enclosure;

FIG. 23C shows a sample application of a focal designation as a framer framing the side of a focal enclosure;

FIG. 24 shows a sample application of a full framer;

FIG. 25 shows a sample application of a shadow framer;

FIG. 26 shows a sample application of a whole foregrounder;

FIG. 27 shows a sample application of a partial foregrounder;

FIG. 28 shows a sample application of a shadow foregrounder;

FIG. 29 shows a sample application of a combined foregrounder;

FIG. 30 shows a sample application of a whole backgrounder;

FIG. 31 shows a sample application of a partial backgrounder;

FIG. 32 shows a sample application of a shadow backgrounder;

FIG. 33 shows a sample application of a portion indicator qualifier;

FIG. 34A shows a sample application of a first embodiment of an entangler;

FIG. 34B shows a sample application of a second embodiment of an entangler;

FIG. 34C shows a sample application of a third embodiment of an entangler;

FIG. 35A shows a sample application of a first embodiment of angle reference qualifiers;

FIG. 35B shows a sample application of a second embodiment of angle reference qualifiers;

FIG. 36 shows a sample application of a smalliff;

FIG. 37A shows a sample application of a shadow smalliff;

FIG. 37B shows a sample application of a repeated smalliff;

FIG. 38 shows a sample application of general filmic qualifiers;

FIG. 39 shows a sample application of a dissolve;

FIG. 40A shows a sample application of a within film;

FIG. 40B shows a sample application of an extensive within film;

FIG. 41 shows a sample application of a film over;

FIG. 42 shows a sample application of an inset film;

FIG. 43A shows a sample application of a double vertical split screen;

FIG. 43B shows a sample application of a triple vertical split screen;

FIG. 43C shows a sample application of an horizontal split screen;

FIG. 44 shows a sample application of simultaneous audio;

FIG. 45A illustrates the symbols for off-level camera;

FIG. 45B shows a sample application of an off-level camera;

FIG. 46 shows a sample application of author comments;

FIG. 47 shows a sample application of a shadow modifier;

FIG. 48 shows a sample application of height differences of focal designations;

FIG. 49 shows a sample application of continuity in visual notes.

### DETAILED DESCRIPTION OF THE PREFERRED EMBODIMENT

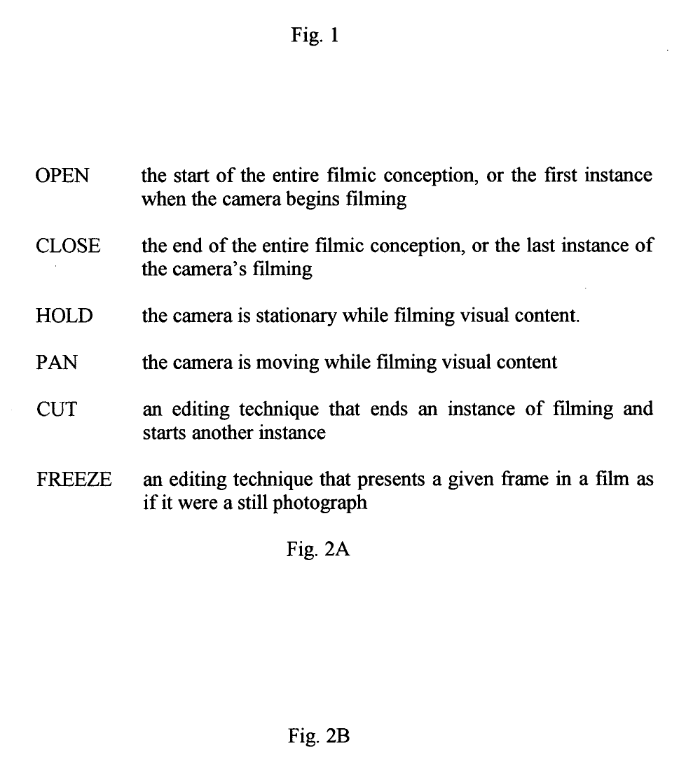

Referring now to the drawings, FIG. 1 shows a sample of a vertical bar, which is used to identify visual notes. The vertical bar is formed by a vertical line (an upright virgule) that is placed at the left margin and whose length depends on the graphic vertical length of the information given for the visual note.

Considering FIG. 2A, all extension of thought is made possible through physical phenomena. This is true of speech, writing, pictures, etc. The particular aspects of the physical phenomena extending thought are what define a particular media. The actual application of a media's particular aspects to the extension of thought creates the state of the media in regard to what is extended. This application is called a media coordinate, from which it follows that a media coordinate signifies the state of the media in regard to what is extended.

In the media film, the particular aspects of the physical phenomena extending filmic thought are made possible through film technology. In this present invention, the applications of this technology are called filmic coordinates. Filmic coordinates set the state of the media film in regard to the visual content being extended. They are inseparable from and pervade filmic thought; and conversely, they represent the actual applications of the film technology that create the state of the visual content being extended. From the foregoing it follows that filmic coordinates are filmic aspects of the film media. In this invention, the filmic coordinates are adapted from conventional state-of-the-art usage but always presented in the distinctive word form illustrated in FIG. 2A.

The filmic coordinate, as shown in FIG. 2B, is written in the distinctive form of all capital letters and in the distinctive placement immediately following a vertical bar. Coordinate auxiliaries, words such as “in,” “on,” and “at” written in the distinctive form of lower case letters, usually accompany a filmic coordinate to help implement it and have the distinctive placement of following it.

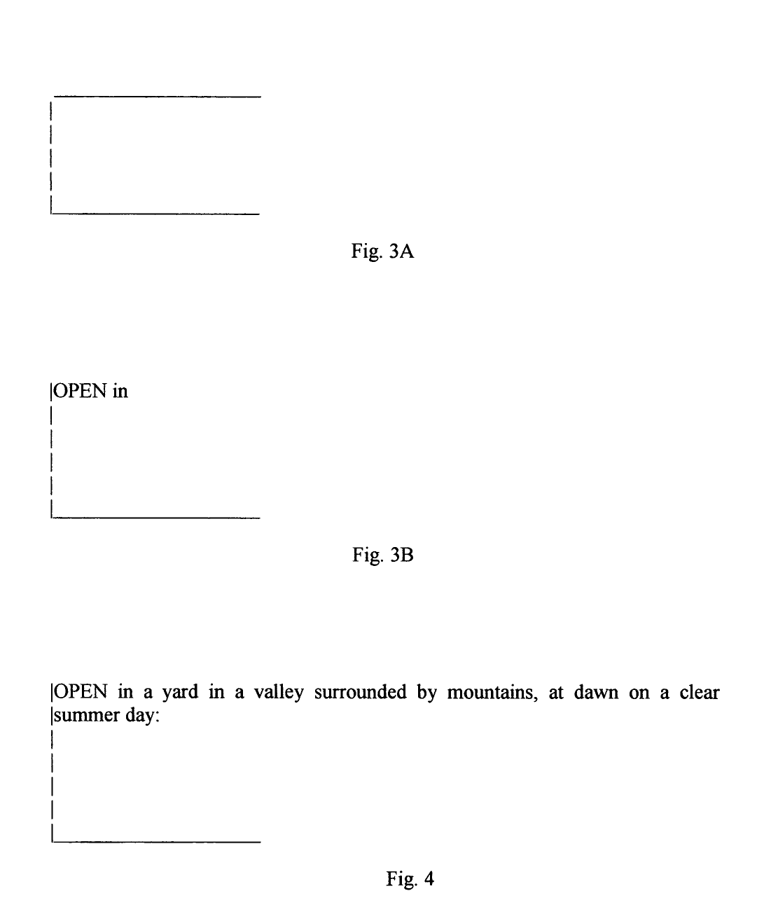

The focal enclosure is the spatial form that contains the visual content of a film and, thereby, sets the spatial limits for that content. Within the film media itself, the focal enclosure is the film screen, from which it follows that the focal enclosure is a filmic aspect of the film media. Within the present invention, the focal enclosure is represented by the filmic staff, as shown in FIG. 3A. Thus, by representing the film screen, the filmic staff functions in the present invention as a filmic aspect of the film media.

As shown in FIG. 3A, the filmic staff consists of two parallel horizontal lines that start adjacent to a vertical bar. The spacing of these lines should relate to the presentation surface proportionally according to the following dimensions for the parallel lines when the presentation surface is an 8½ in.×11 in. page: the lines run horizontally approximately 1⅝ in.; and the lines are separated vertically by approximately 1 in. (Another embodiment is a horizontal line of approximately 1½ in. and a vertical separation of approximately ¾ in.)

The words that make up a filmic coordinate, as shown in FIG. 3B, substitute for the top line of the filmic staff to form a simplified staff, in which the bottom of the filmic coordinate suggests the location of an imaginary line that serves as the top parallel line of the filmic staff. This imaginary line's horizontal length is determined by the length of the bottom line of the filmic staff.

The focal field refers to all that appears within the focal enclosure at a given moment. Like the focal enclosure, it is a filmic aspect of the film media. In the present invention, the focal field is represented through two elements: the focal place and the focal designation.

The focal place identifies the nomination and predication within the focal field that advance meaning in filmic thought as to where and when and in what circumstances (such as regarding weather). Although an element within the focal field, a filmic aspect, the focal place itself is a contained aspect. Therefore, in the present invention, as shown in FIG. 4, the focal place is represented through a distinctive placement of conventional word usage. Such word usage is called contained descriptive detail, which, for the focal place, is written in lower case letters as a grammatical continuation of a filmic coordinate and coordinate auxiliary. The focal place ends in a colon. If additional description is necessary, the initial phrases or clauses end with a period instead of a colon; and the description is written in sentences, with the last one ending in a colon. If the focal place extends beyond one line, then each line of the focal place is preceded by a vertical bar. If the focal place does not extend beyond one line, then it joins the filmic coordinate and coordinate auxiliary to form the top of the simplified staff. If it does extend beyond one line, then the last line marks the placement of the top parallel line of the filmic staff.

The focal designation identifies the nomination and predication within the focal field that advance meaning as to persons and things. The focal designation may be the focal field itself, in its entirety, but it usually is one or more components within the focal field. The focal designation functions as the engine for advancing meaning in filmic thought because it is the media element through which the unique filmic aspects of the focal field are presented, albeit in conjunction with assimilated contained aspects

In the present invention, the filmic aspects of the focal designation are represented through the “cube note.” A cube note consists of a designator, a portion indicator, and placement indicators.

The designator represents a given focal designation. As already indicated, the focal designation could be a focal field in its entirety, but it usually is a component in a focal field—or two or more components, each understood as a focal designation and each having its own designator.

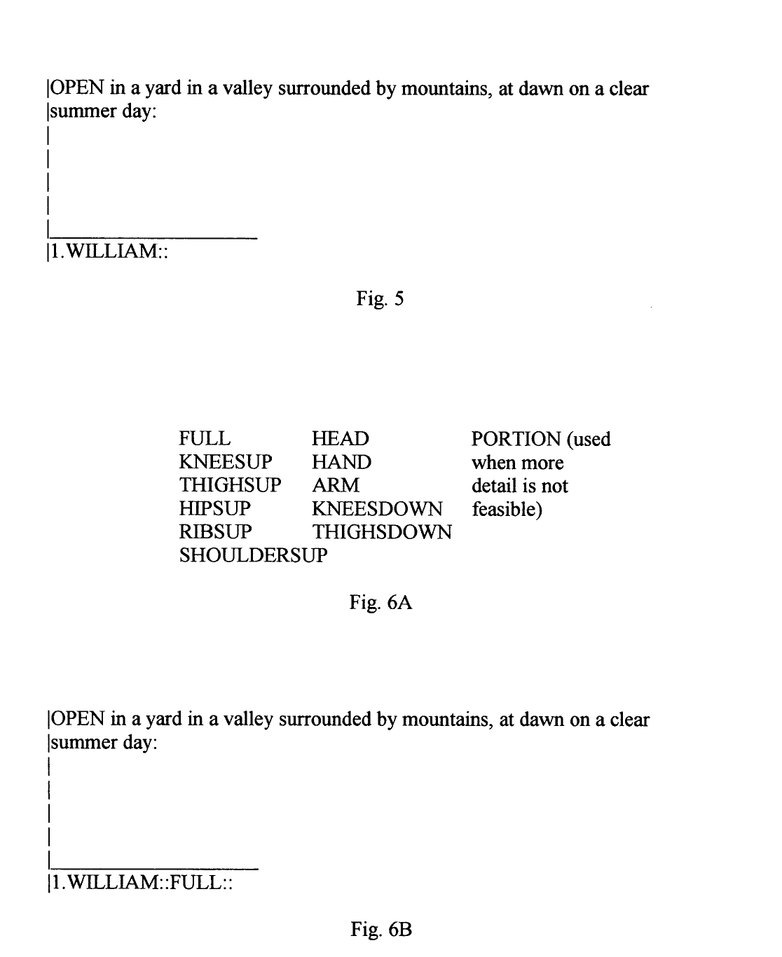

As shown in FIG. 5, the designator consists of a number and a name written under the filmic staff, following a vertical bar. The designator number is written immediately after the vertical bar and in alignment with the left margin set by the filmic staff. The number is followed by a period. The designator name is written in all capital letters immediately after the period following the number. The name is followed by a double colon.

The portion indicator represents the portion of the focal designation appearing in the focal field. It consists of distinctive word forms. FIG. 6A illustrates some of the more frequently used portion indicators. As shown in FIG. 6B, the portion indicator is written in all capital letters immediately following the double colon that follows the designator name. The portion indicator itself is followed by a double colon.

The placement indicators represent the spatial location of a focal designation within a focal field. There are three distinct placement indicators that work jointly to represent this location: the angle reference, the plane reference, and the depth reference.

The angle reference represents the placement of the focal designation regarding its angular position within the focal field. It accomplishes this task by assuming that the focal designation is enveloped within an imaginary cube. It assumes that only what is represented by the designator and the portion indicator is enveloped within this imaginary cube. Working from this basis, the angle of the focal designation within the focal field can be represented by the angle of the imaginary cube.

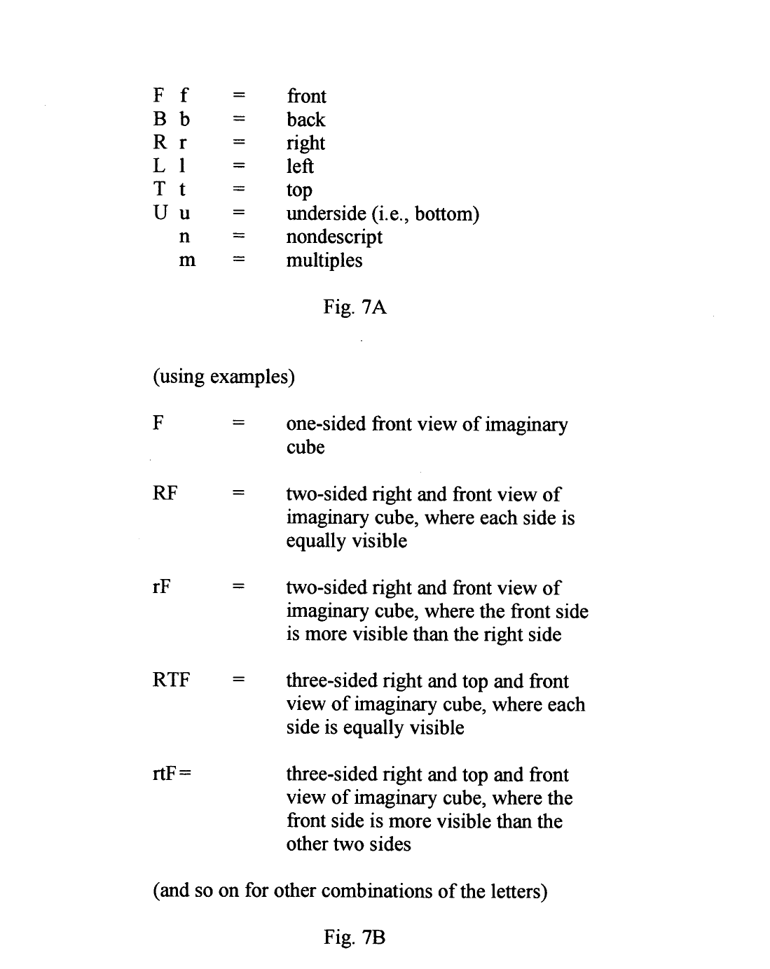

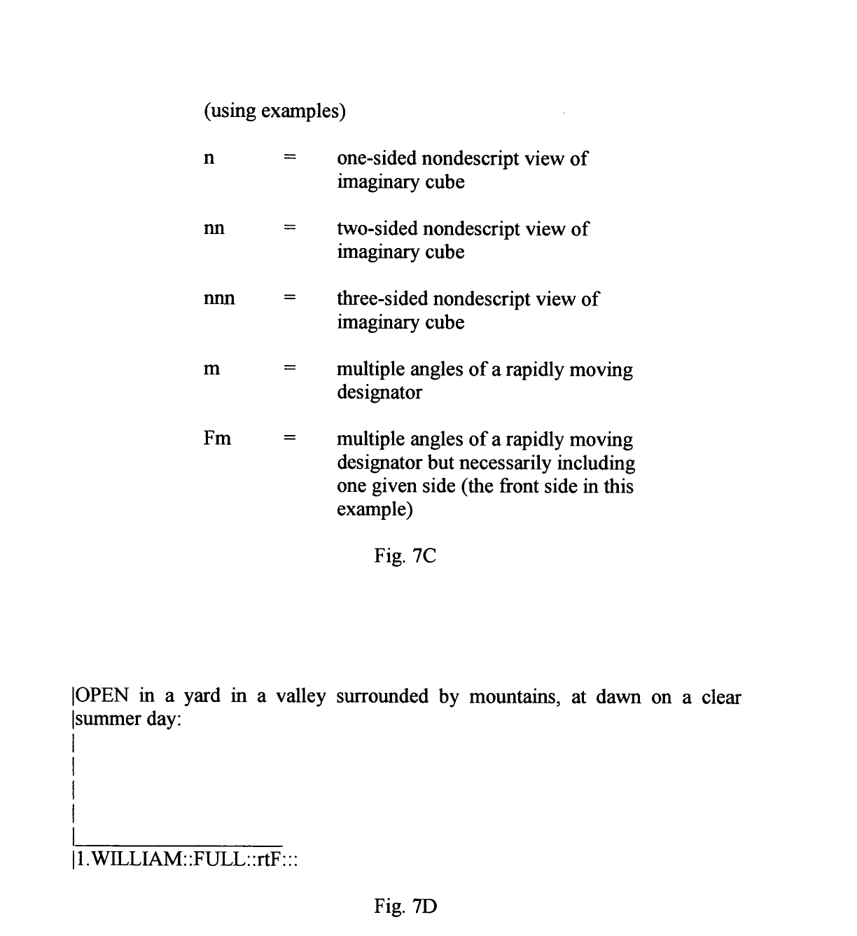

To indicate the angle of the imaginary cube, the sides of the cube are represented by letters applied as symbols that have the meanings illustrated in FIG. 7A, with the additional interpretation that a capital letter is used to indicate dominance or equal dominance in visibility of a side and a lower case letter is used to indicate subordination in visibility of a side.

When two sides of the imaginary cube are visible, the order of referencing the letters to the sides is left to right. When three sides are visible, the order of referencing the letters to the sides is clockwise, beginning with the side all of which is left-most of the other two sides. Referencing the letters in these manners, the angle of the imaginary cube—and, therefore, the angle of the focal designation within the focal field—can be represented as illustrated in FIG. 7B and FIG. 7C.

As shown in FIG. 7D, the letters of the angle reference are written immediately following the double colon that follows the portion indicator. The angle reference itself is followed by a triple colon.

The imaginary cube enveloping the focal designation should be understood as elastic rather than rigid. For example, the angle reference letter “F,” when given alone, does not mean that some of “r” or “1” or “u” are absolutely excluded. The same principle applies if, say, “rF” or “RF” are the angle reference letters. What is meant by a given angle reference letter is that the side represented by the letter is definitely present—in the dominant, subordinate, or equal level indicated by use.

The plane reference represents the placement of the focal designation regarding its apparent horizontal and vertical position within a focal field. The plane reference accomplishes this task by representing an imaginary placement of the angle reference's imaginary cube within the filmic staff. This representation itself is accomplished by the actual placing of the designator number in a position within the filmic staff approximating the actual position of the focal designation within the focal field. In this way, the designator number in the filmic staff stands for the location—within a focal field—of the imaginary cube enveloping the focal designation, while assuming—for the focal designation—the portion given by the portion indicator and the angle given by the angle reference. In addition, the base of the number, wherever it is placed within a filmic staff, represents the center of the base of the imaginary cube, which is understood to expand from that base point into the focal field in correlation with the obvious limits prescribed by the portion indicator and according to the angle prescribed by the angle reference.

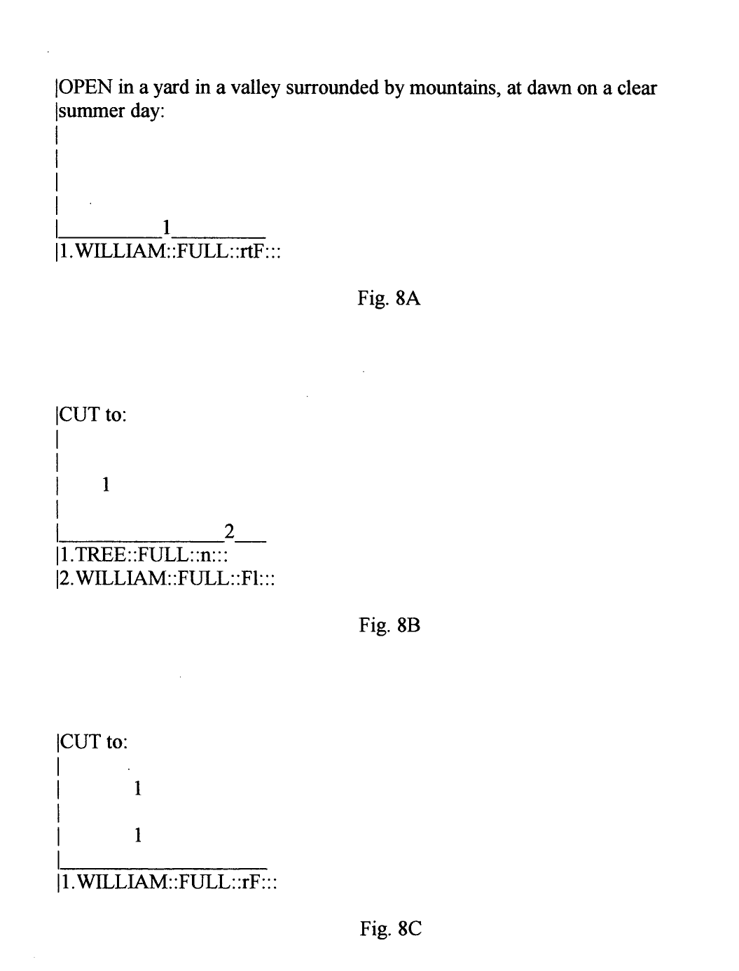

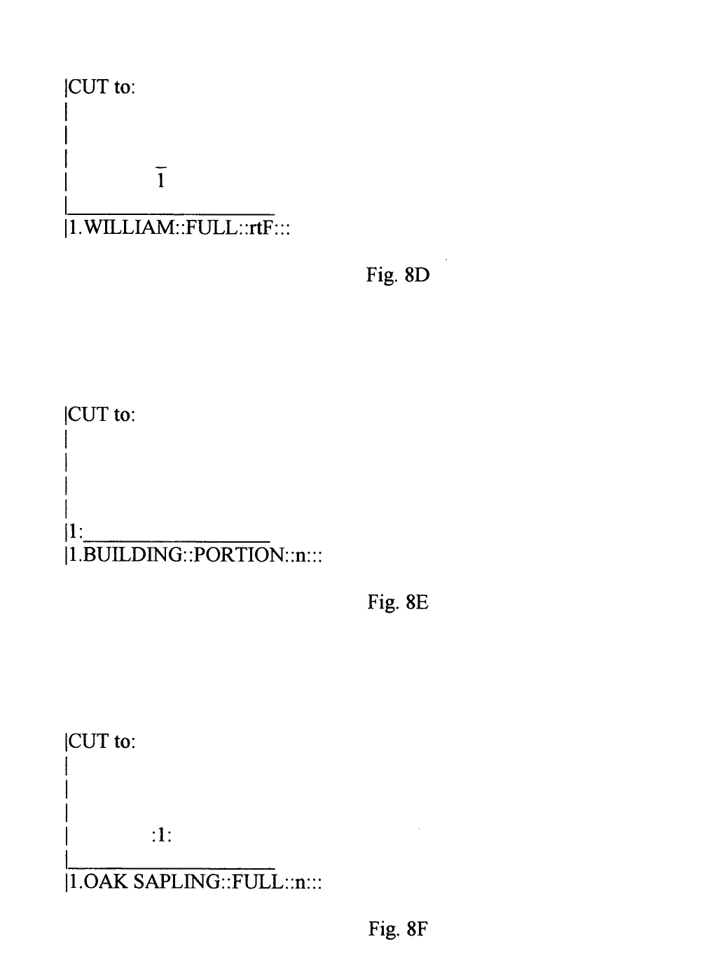

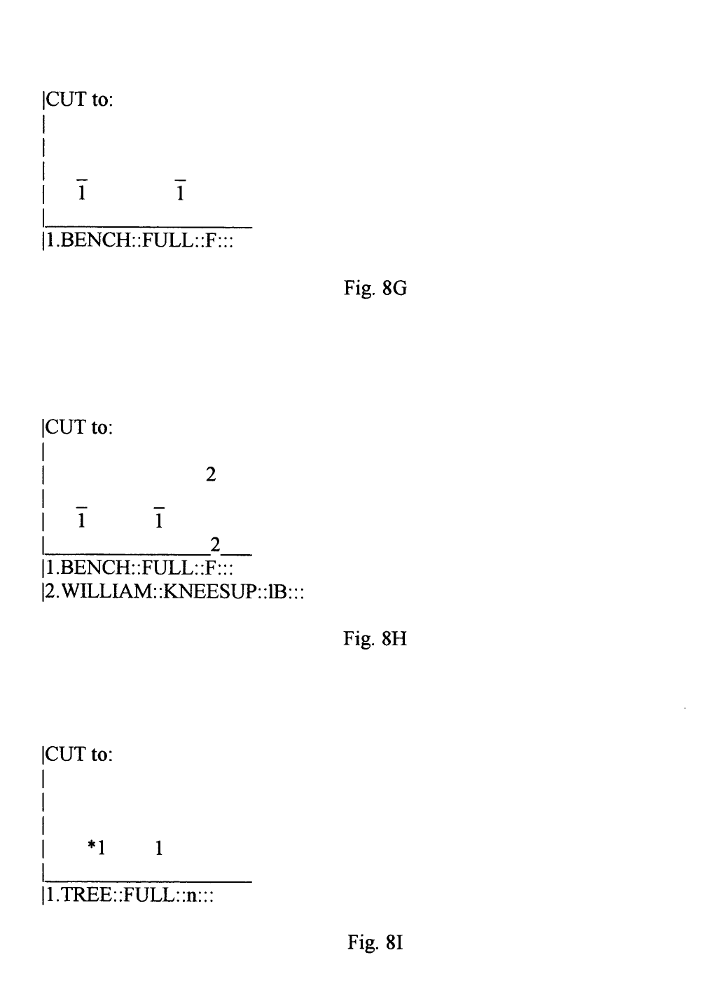

FIG. 8A shows that when one focal designation occurs in a focal field, it is represented by a designator (name and number) under the filmic staff and a designator number within the filmic staff, wherein: the designator number in the filmic staff corresponds to the designator number under the filmic staff; the bottom of the number within the filmic staff represents the bottom of the imaginary cube enveloping the focal designation; and the imaginary cube is understood as upright regarding a normal top versus bottom position, and the cube extends to the top of the filmic staff. FIG. 8A also shows that the bottom filmic staff line is interrupted under the designator number, which is permitted when the designator number is placed at the lowest position of the filmic staff.) Thus, in the sample in FIG. 8A, William is in the yard and all of him is visible, filling the screen from the bottom to the top, in a three-sided right/top/FRONT view in which the front view is dominant.

FIG. 8B shows that when two or more focal designations occur in a focal field, each is represented by a designator under the filmic staff, and each designator number appears in the staff. The designator numbers begin with the number 1 and, then, 2, 3, etc., from a top down order under the filmic staff and a left to right order and then top to down order in the filmic staff. Thus, in FIG. 8B, William and the tree are both in the focal field, and each extends to the top of the focal field, with William starting from the bottom and the tree starting about midway.

FIG. 8C shows that when the focal designation does not extend to the top of the focal field, a second of the same number is placed at the position in the filmic staff that represents the location of the focal designation's top. In such an application, the bottom of the imaginary cube is represented by the bottom of the designator number in the lower part of the filmic staff; and the top of the imaginary cube is represented by the top of the designator number in the upper part of the filmic staff. Thus, in FIG. 8C, the bottom of William does not extend to the bottom of the focal field, nor does his top extend to the top of the focal field.

FIG. 8D shows that when the focal designation does not extend vertically in the focal field any farther than does the designator number itself in the filmic staff, a vertical limiter (a short line) is placed above the designator number in the filmic staff to indicate that the top of the number represents the position of the top of the focal designation, while the bottom of the imaginary cube is represented by the bottom of the designator number. Thus, in FIG. 8D, William is in the middle of the focal field and viewed from a distance.

FIG. 8E shows that when the focal designation does not extend horizontally in the focal field any further than the designation number itself, a horizontal limiter (a colon) is placed on the side of the number in the filmic staff beyond which the focal designation does not extend. If the focal designation's extension is limited on both sides, the horizontal limiter is placed on both sides, as shown in FIG. 8F.

Some focal designations can more easily be interpreted as being enveloped by an imaginary noncubical rectangular box than a cube. In such situations the angle of the focal designation can still be referenced by the cube's six reference letters. The plane, then, is referenced by placing two of the same number in the filmic staff in locations to approximate the extremes of the position of the focal designation in the focal field. The center of the base is understood as being midway between the two numbers. This application is shown in FIG. 8G, where the interpretation is that the bench is positioned in the lower part of the focal field (by the placement of numbers and the vertical limiters.)

FIG. 8H shows that when more than one focal designation occurs in a focal field and one is better represented as being enveloped by an imaginary cube and the other by an imaginary noncubical rectangular box, each is represented accordingly, one as if enveloped by a cube and the other by a noncubical rectangular box. Thus, in FIG. 8H, the interpretation is that William is standing next to the bench.

It is always assumed that the top of a focal designation appears upright in the focal field. When the situation is different and the top appears other than upright, this is indicated, as shown in FIG. 81, by placing two designator numbers in the filmic staff, in the manner of representing a noncubical rectangular box, as in FIG. 8G, and by placing a top marker (an asterisk) to the outside of the designator number representing where the top is located. Thus, in FIG. 81, the interpretation is that the tree is lying on the ground in the middle of the focal field.

If a focal designation extends to the top of a focal field but the top of the focal designation does not appear upright, the top marker can accompany a single designator number placed in the filmic staff, as shown in FIG. 8J, where the interpretation is that the wheelbarrow is turned upside down and resting on its top.

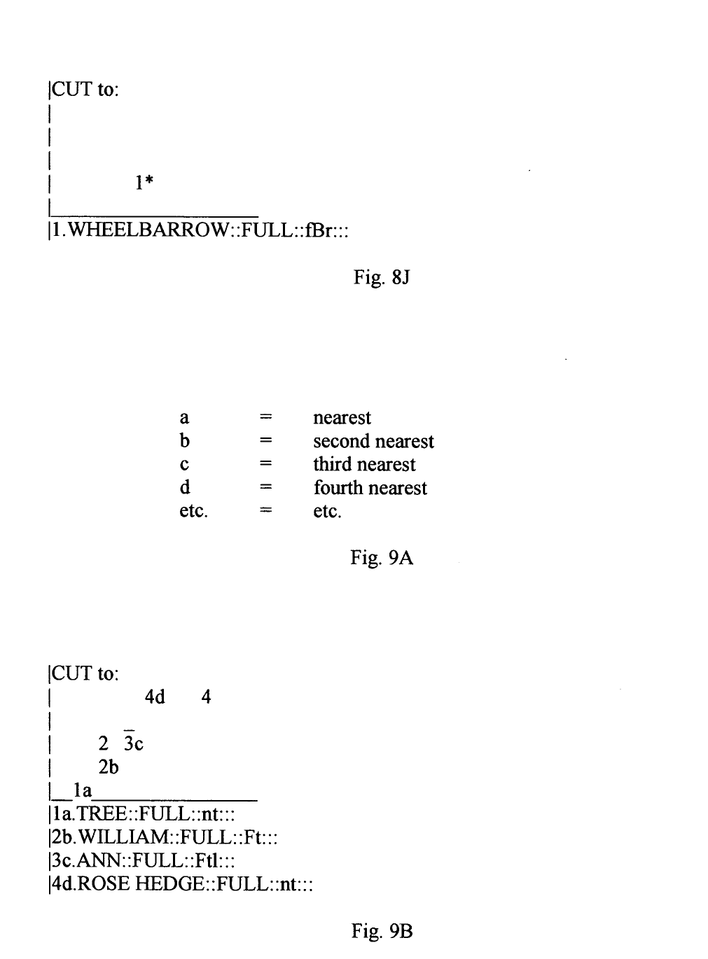

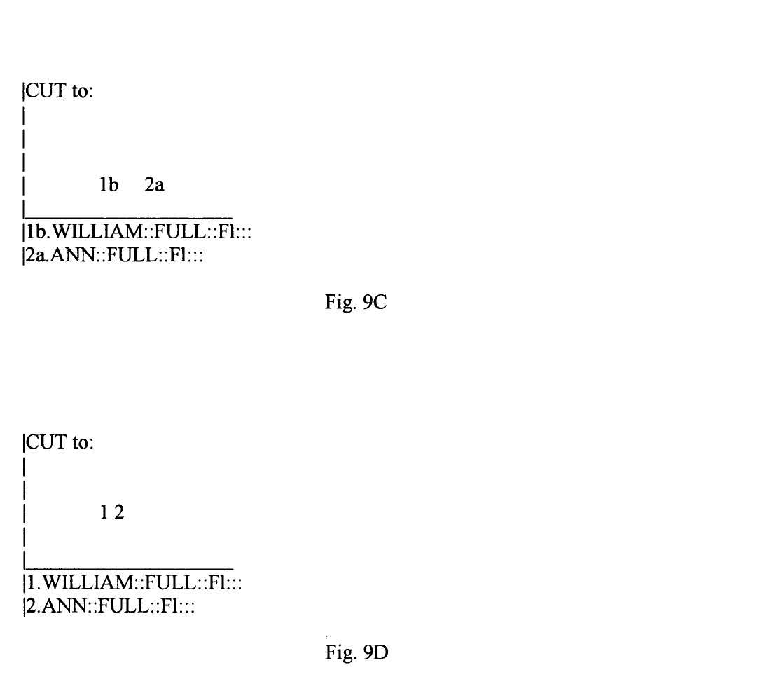

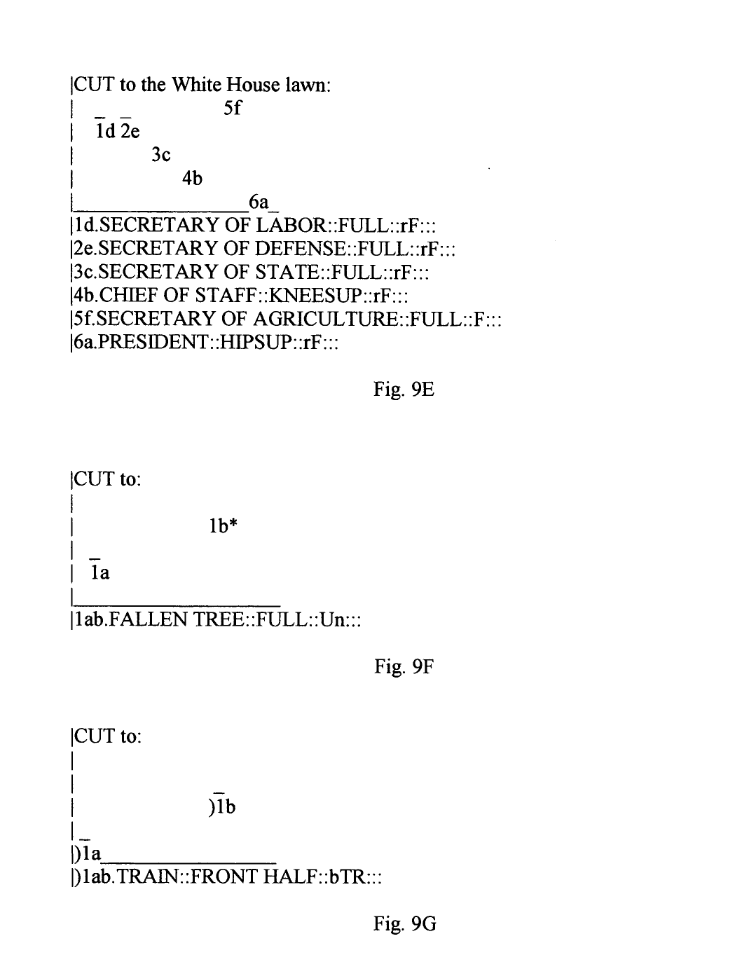

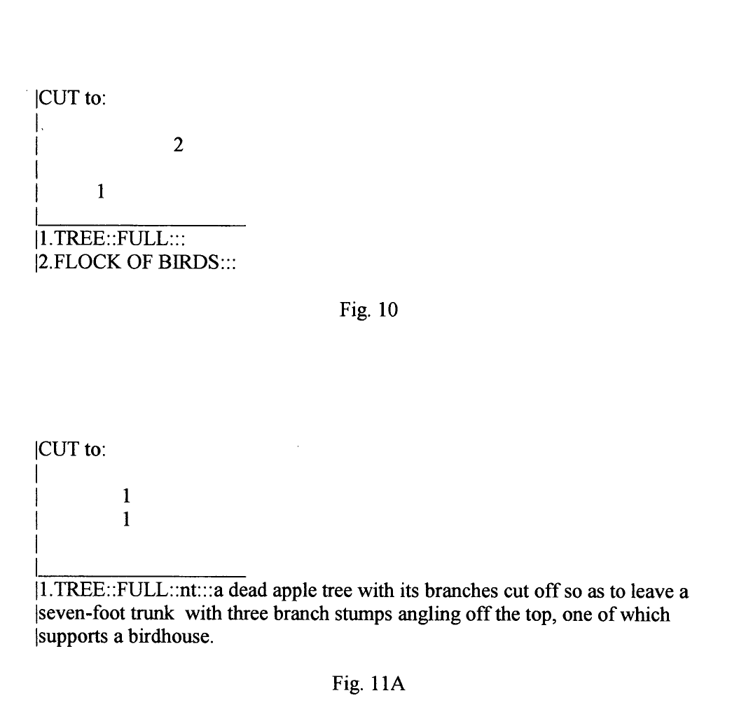

The depth reference represents the placement of a focal designation in regard to its depth relationship with other focal designations in the focal field. The depth reference is represented by a depth reference letter, with meaning attached to the letters as illustrated in FIG. 9A.

FIG. 9B shows an application of the depth reference letters. The designator number and the correlating depth reference letter are written next to each other in the filmic staff, without intervening spaces, in a position approximating the actual position of the focal designation within the focal field. If the focal designation is represented by two of the same number in a vertical alignment, only the bottom number in the filmic staff is followed by the appropriate letter (as in the case of 2b in FIG. 9B). If the focal designation is represented by two of the same number in a horizontal alignment, only the left number in the filmic staff is followed by the appropriate letter (as in the case of 4d in FIG. 9B). The designator number and the correlating depth reference letter are also written under the filmic staff—next to each other and followed by a period and without any intervening spaces—before the appropriate designator name (as shown in FIG. 9B). Thus, the interpretation regarding the application of depth reference letters shown in FIG. 9B is: The tree appears nearest in the focal field; all of it appears in a nondescript/top angle in the left-most portion of the focal field and extends from the bottom to the top of the field. William appears in a FRONT/top angle closest to the tree, with all of him visible but none of him reaching to the top or the bottom of the focal field. Ann appears in a FRONT/top/left angle farther from the tree than William, with all of her visible and reaching about as high as he in the focal field but not as low. The rose hedge appears farthest in the focal field; all of it appears in a nondescript/top angle in the upper right-most portion of the focal field.

If two focal designations have essentially the same plane reference in the focal field but one is forward of another, the designator numbers are written on the same vertical placement on the filmic staff, and their depth relationship is indicated by the depth reference letters. This application is shown in FIG. 9C, where the designator numbers are written on the same vertical line on the filmic staff and the appropriate depth reference letters are written immediately after the corresponding designator numbers both in the filmic staff and under it. Thus, the interpretation of the application in FIG. 9C IS that William and Ann are walking side-by-side, with Ann slightly ahead of William.

If two focal designations have essentially the same plane reference and the same depth reference in the focal field, their designation numbers are both written in the filmic staff without depth reference letters, as shown in FIG. 9D.

More than four levels of depth reference should be avoided. If needed, however, additional levels may be indicated by continuing to give each focal designation a designator number and continuing to place a depth reference letter after the designator number to correspond to the appropriate depth relationship (i.e., continuing with letters e, f, g, etc.). As shown in FIG. 9E, when more than four focal designations are being detailed in the staff, the corresponding designator number for each is written in the appropriate place in the filmic staff, with each designator number written in sequence (1, 2, etc.), following a left to right order and then a top to bottom order, and then the appropriate depth reference letter corresponding to its depth relationship written next to it. Under the filmic staff, the depth reference letter corresponding to the appropriate depth relationship of the given focal designation is written after the number. The sequence of numbers need not correspond to the sequence of letters. (The sequence could be 1b, 2a, etc.) Thus, in FIG. 9E, the interpretation is that the president and his staff are on the White House lawn, with the president appearing foremost in the focal field.

The depth reference combines with the concept of the imaginary noncubical rectangular box to notate a focal designation that is not easily perceived as being enveloped in a cube and that is positioned in the focal field so as to occupy different depths. As shown in FIG. 9F, two of the same number are written in the filmic staff to represent the plane of a focal designation understood as being enveloped by an imaginary noncubical rectangular box. Then, the different depth relationships of the extremes of the focal designation are represented by writing the corresponding depth reference letter next to the number. Under the filmic staff, the letters are written next to the corresponding designator number. Thus, the interpretation for FIG. 9F is that the tree's base is in the lower left of the focal field and its top is in the upper right (because of the location of the top marker), with the base appearing nearer than the top.

In a situation where the focal designation bends, creating the effect of a curved noncubical box, a curve symbol (a parenthetical punctuation mark) is placed in front of the designator number both in the filmic staff and under it to represent the curve. The symbol (represents a curve to the right; and the symbol ) represents a curve to the left. This application is shown in FIG. 9G, where the interpretation is that the train is bending to the right, with the midsection of the train appearing in the lower left of the focal field and the front portion appearing in the right middle of the focal field.

Some situations are best treated with an abridgement of the filmic aspects. In these situations, either the angle reference or the portion indicator or both are not necessary for advancing meaning regarding the focal designation; and therefore, these filmic elements can be omitted. In such instances, the designator name or the portion indicator is followed by a triple colon rather than a double colon, as illustrated in FIG. 10.

The contained media aspects relevant to the present invention are those assimilated into the film media from other media. Because these aspects are not unique filmic aspects, they do not require a unique representation and are always represented through descriptive detail presented through conventional word usage, which in the present invention is called contained descriptive detail. When such contained descriptive detail modifies a designator under a filmic staff, conventional word usage is employed but with special adaptations for the present invention regarding form and placement.

FIG. 11A shows that when it is presented as a graphic continuation of a designator, portion indicator, and placement indicator under the staff, the contained descriptive detail is written in a modifying, or subordinate, format. It is written in all lower case letters, beginning after the triple colon that follows the angle indicator, and with no spaces between the triple colon and the first word of the detail.

The contained descriptive detail contributing to a visual note may be written in full sentences, especially when more information is required. This type of descriptive detail, which is called contained descriptive detail extension, is written on a new line beginning immediately under the last designator (and whatever corresponding information appears with the designator), as shown in FIG. 11B.

Descriptive detail, even though the contained media aspect of visual content, can be used to simplify the notation of the unique media aspects of visual content. For example, FIG. 9E could specify the filmic aspects for the president alone and use contained descriptive detail to reference the presidential staff.

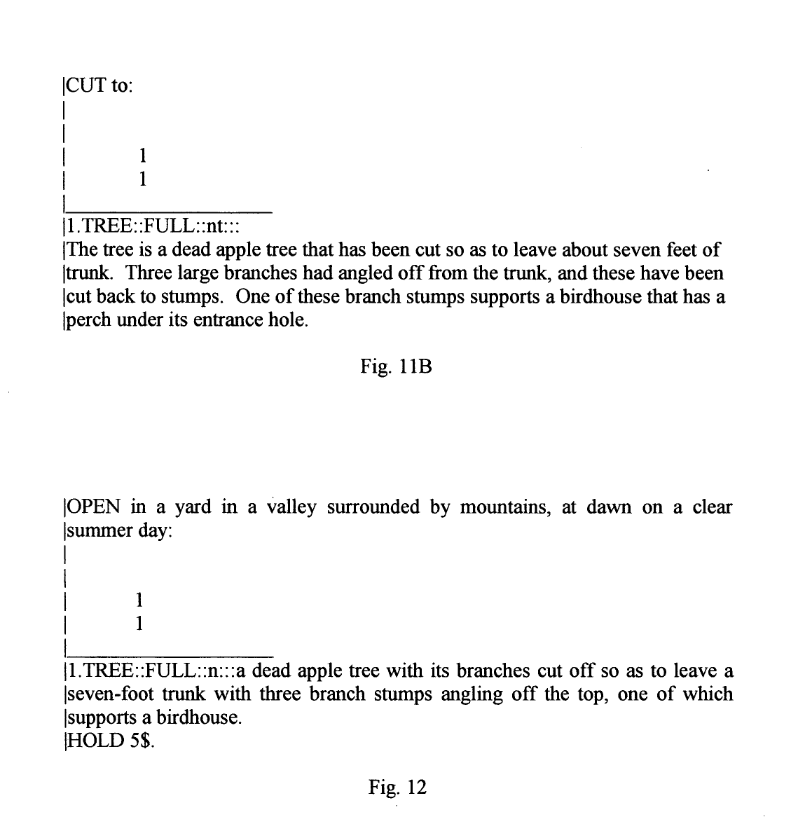

Time is derived from the context of the filmic content, and the duration of a filmic coordinate is understood by this context and especially any accompanying contained descriptive detail. The duration of a filmic coordinate also may be specified by the time indicator, in which the symbol $ stands for a second of time, with number of seconds indicated by numbers, such as in 1$, 2$, etc. The time indicator is used with three filmic coordinates, “HOLD,” “PAN,” and “FREEZE FRAME.” FIG. 12 shows the application of one of these.

FIG. 12 also shows a completed visual note. It begins with the filmic coordinate OPEN, which is called a lead-in coordinate, and ends with the filmic coordinate HOLD, which is called a lead-out coordinate; and it is graphically identified by a continuing vertical bar on the left margin. A completed visual note such as the one in FIG. 12 is also called a staff array, and a staff array is understood as functioning in the present invention as a fulcrum for whatever follows it, until altered by another notation entry.

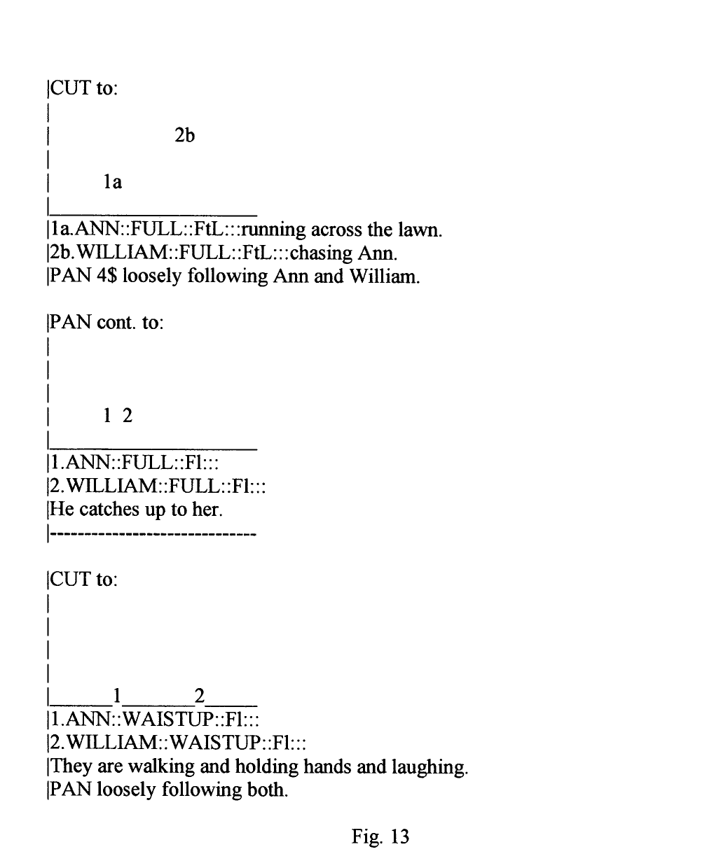

An end bar is used in place of a lead-out coordinate when there has been a change in a focal field for which a previous lead-out coordinate has served as a fulcrum but for which no new lead-out coordinate is needed because the focal field is ending. FIG. 13 shows an application of an end bar (at the end of the second staff array). It is written as a broken line as long as the horizontal line of the filmic staff; it substitutes for the filmic coordinate and becomes the last line of a staff array; and the staff array that follows one that ends in an end bar always begins with the lead-in coordinate “CUT to.”

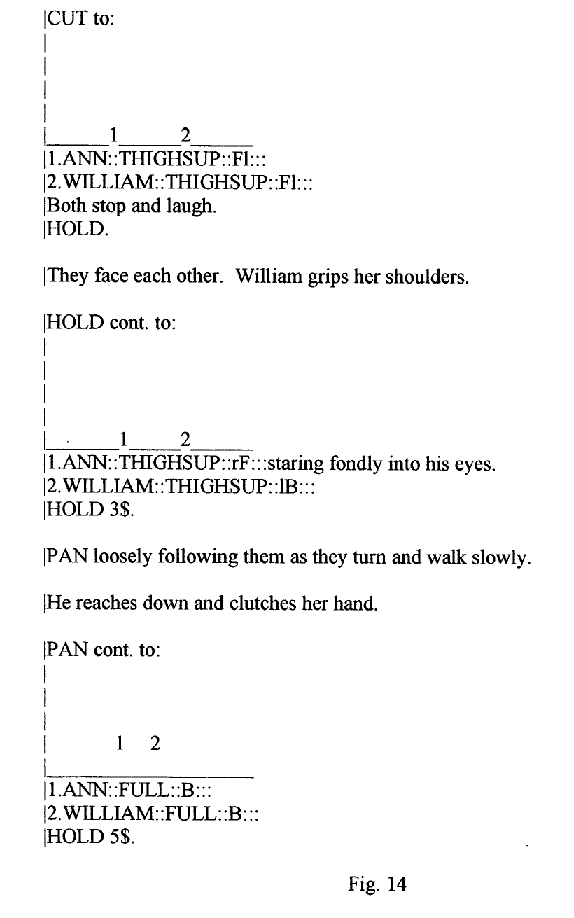

A focal modifier modifies the information presented in a preceding staff array without requiring a complete restatement of the information. A focal modifier may be: contained descriptive detail, a filmic coordinate, or a filmic coordinate with correlating contained descriptive detail. As shown in FIG. 14, a focal modifier is set off by a line space preceding it and another following it. Each line of a focal modifier is preceded by a vertical bar and then written in a left alignment. When a focal modifier consists of only contained descriptive detail, it is written in standard sentence format, though with the distinctive placement just described. When a focal modifier includes a filmic coordinate, the filmic coordinate itself is written in all capital letters and the rest of the focal modifier is written in lower case letters as a grammatical continuation of the filmic coordinate and, at the end, followed by a period. A focal modifier can be followed by another focal modifier without an intervening staff array. When it is, however, it still relates back to the preceding staff array.

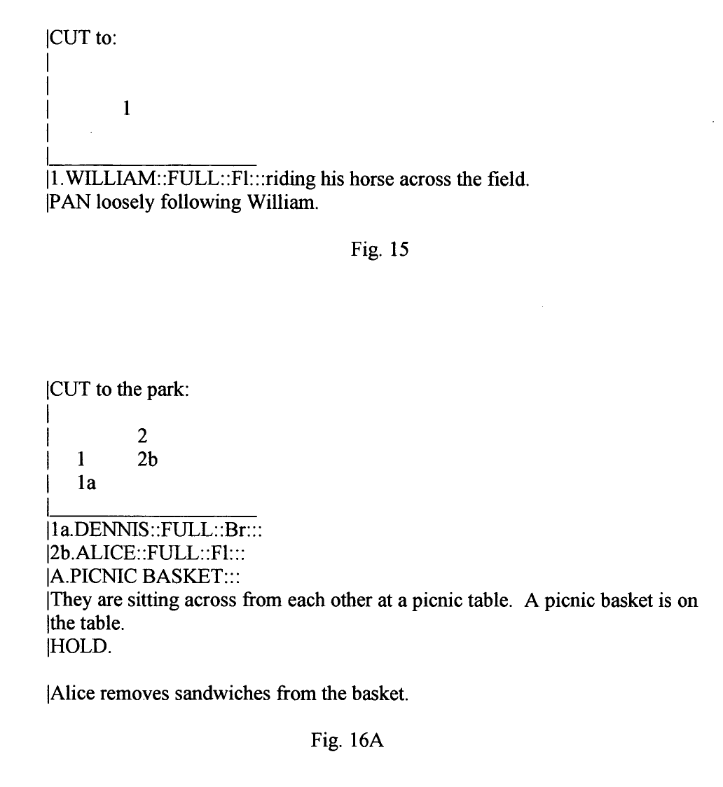

An assumed focal designation is one that is understood as present without having to be specifically notated. This application is shown in FIG. 15, where the horse is understood as necessarily present yet does not require specific notation because its filmic aspects are sufficiently inferred from those regarding “William.”

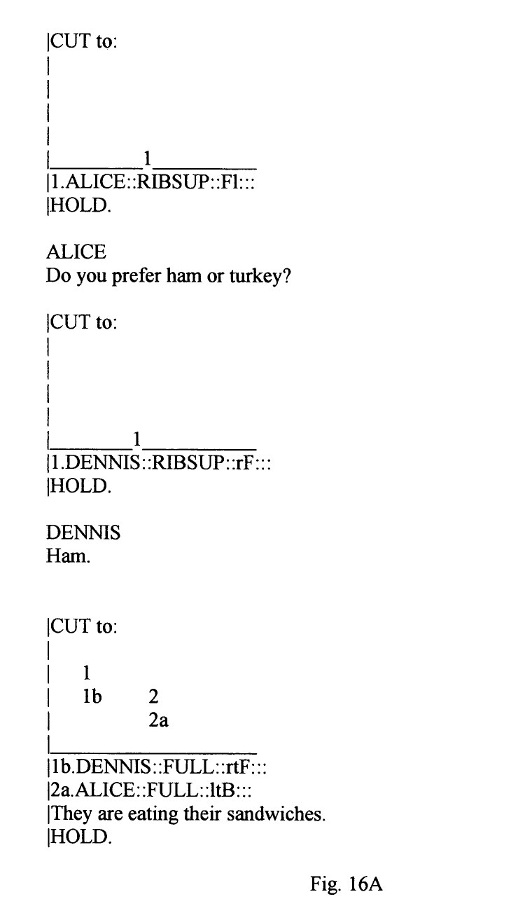

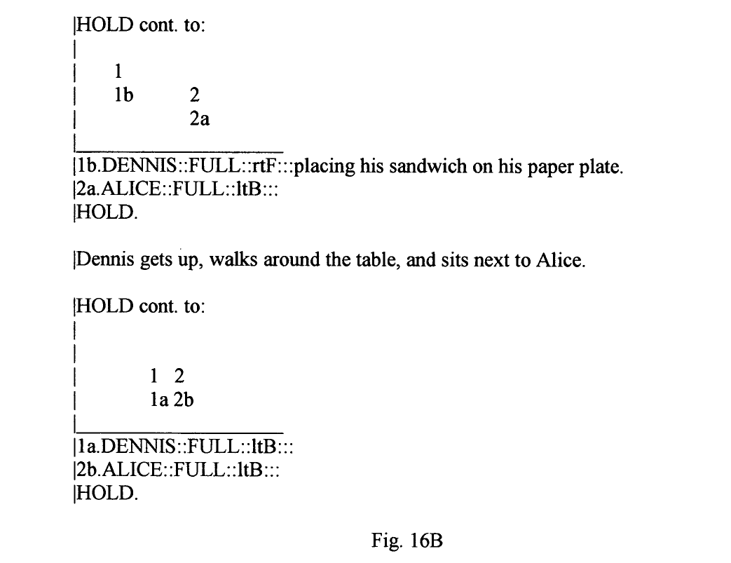

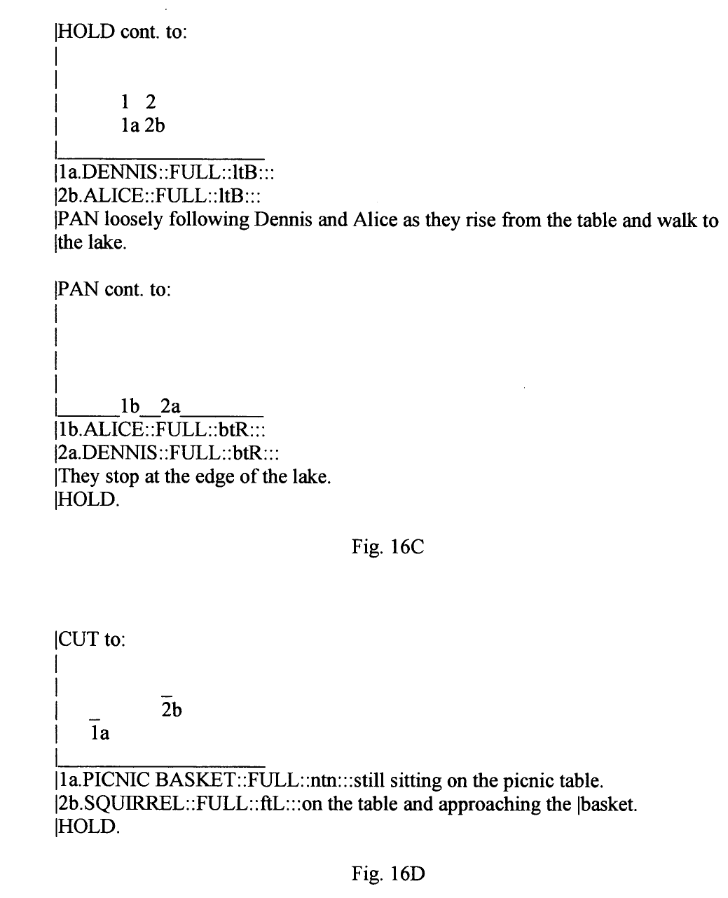

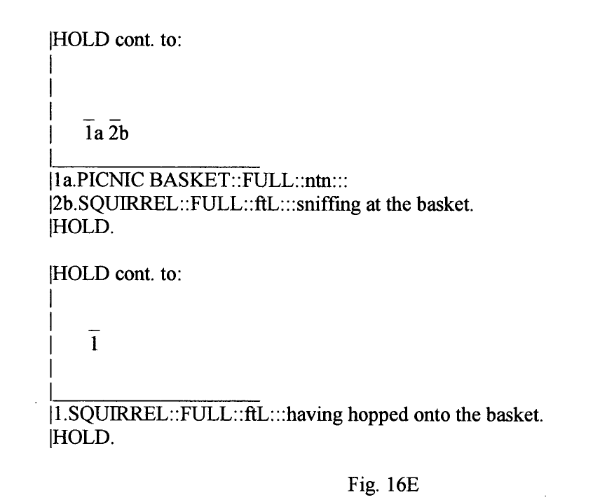

Continuity is a property intrinsic in the advancement of meaning. In the present invention, continuity in visual notes is effected through an assumption of “abiding precedent.” This assumption means that descriptive detail given to build up a visual note is assumed as abiding for subsequent visual notes until new descriptive detail changes the particulars or a new visual note renders the descriptive detail no longer applicable. The descriptive detail does not have to be repeated in subsequent staff arrays to remain in effect for the visual content. FIG. 16A shows a first embodiment of this application in that throughout the sequence of staff arrays, Dennis and Alice remain seated at the picnic table and the picnic basket remains on the table. FIG. 16B shows a second embodiment of this application in that throughout the sequence of staff arrays, Alice hasn't moved but Dennis is now sitting next to her on the same side of the table. FIG. 16C shows a third embodiment of this application in that both Dennis and Alice have moved away from the table but nothing has altered that the basket remains on the picnic table. FIG. 16D shows a fourth embodiment of this application in that the basket remains on the picnic table but is described again for added clarity while a new focal designation, the squirrel, approaches. FIG. 16E shows a fifth embodiment of this application in that the basket remains on the picnic table but its presence is assumed because it has become subordinate to the filmic aspects regarding the squirrel. FIG. 16A through 16D also show that the designator number is assigned anew for each new staff array.

The audio note represents film's audio content that has a significant effect. Because a film's audio content results from contained media assimilated into the film media, the audio note represents film's audio content through conventional presentations for audio in other media but with a distinctive placement for the purpose of correlating film's audio content with its visual content.

In the film media, the audio content occurs simultaneously with the visual content. In the present invention, the presentation of the visual content always precedes the presentation of the audio content, even though the actual occurrence of the two contents may be simultaneous.

The present invention divides film's audio content in two ways. First, film audio content is understood as being either intrinsic audio content or extrinsic audio content. Intrinsic audio is that which is inseparable from the visual content, such as dialogue when a focal designation is speaking. Extrinsic audio is that which is separable from the visual content, such as background music.

Second, film's audio content, whether intrinsic or extrinsic, is understood as consisting of one of the following three types of audio: speech, sound effects, or music.

Speech includes dialogue and narration. It is represented through the following elements: the name of the person speaking; correlating contained descriptive detail—if necessary about the manner in which the person is speaking or about action that occurs simultaneous to the speaking and that is of the sort other media attach descriptively to speech; and the words spoken.

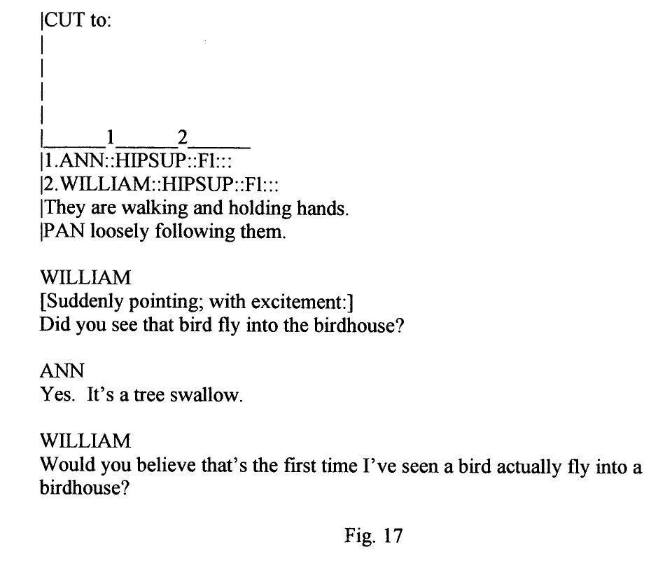

In the present invention, dialogue has a distinctive placement, as shown in FIG. 17, wherein: A double line space always precedes the name of the speaker. The name of the speaker is written in all capital letters and in alignment with the left margin. Contained descriptive detail—about the manner of speaking or about action that occurs simultaneous to the speaking—is written on a separate line immediately under the name of the speaker and is enclosed in brackets in left alignment with the left margin, with its first word beginning with a capital letter, the remaining words written in lower case letters, and a colon placed after the last word and before the closing bracket. The dialogue is written in conventional format on the immediate next line after the name of the speaker or any contained descriptive detail, and it is written in left alignment with the left margin.

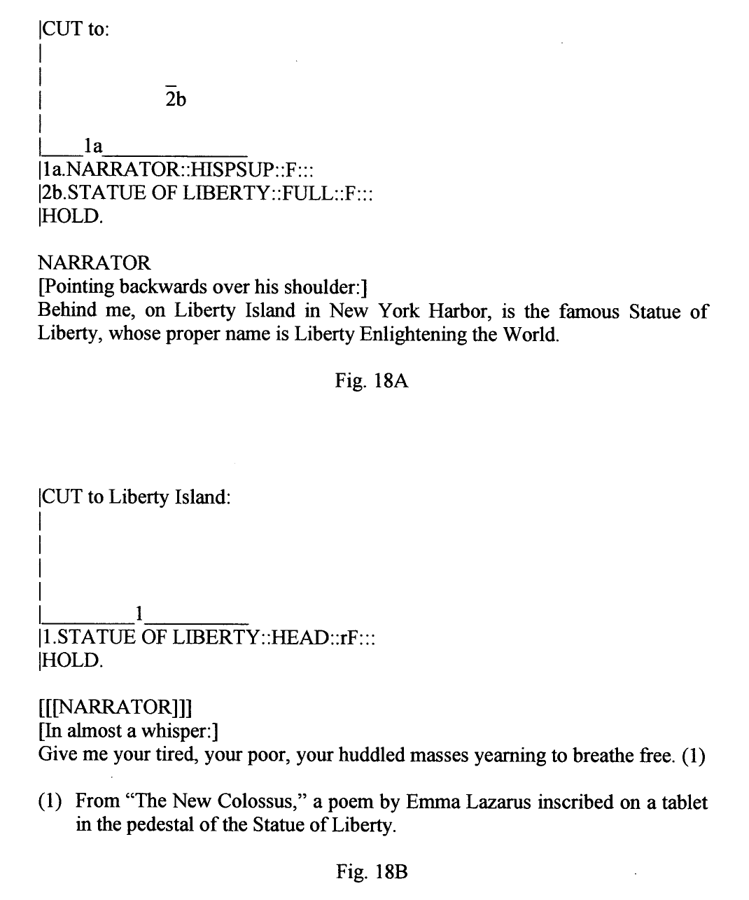

FIG. 18A shows the embodiment for treating intrinsic narration, that in which the narrator is actually one of the focal designations. The application is the same as for dialogue with the exception that the narrator is the named speaker.

To indicate an instance of extrinsic speech, the speaker's name is preceded by a series of three brackets and followed by a series of three brackets, as shown in FIG. 18B. The remainder of the notation elements for extrinsic speech are treated in the same manner as dialogue and intrinsic narration. If any audio content requires a reference, that content is followed by a number in parenthesis, and the reference is treated as a footnote or endnote, as FIG. 18B also shows.

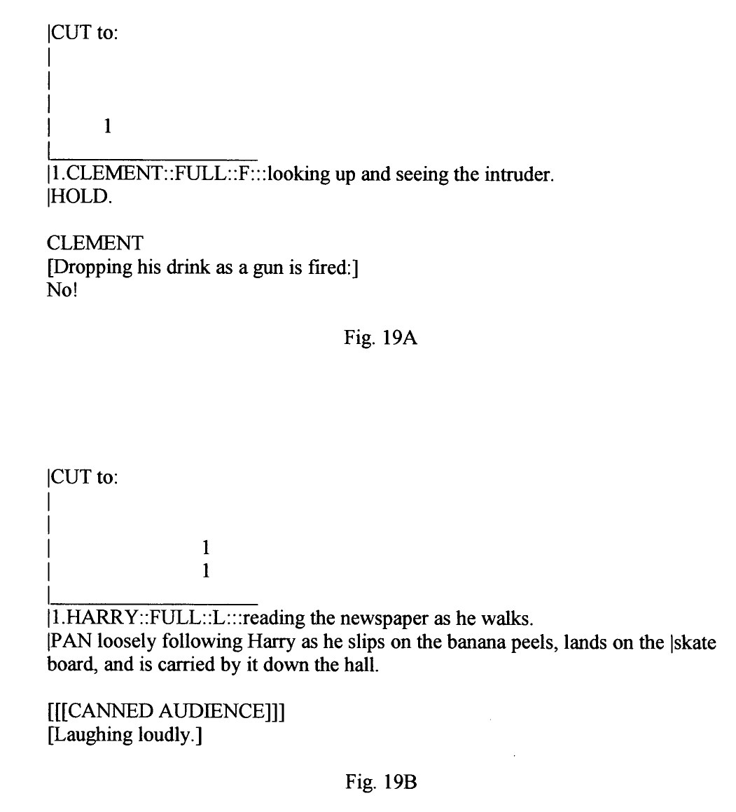

Sound effects include all the sound in a film that is not speech or music. They are represented through conventional word usage description. Intrinsic sound effects result from what would necessarily be understood from contained descriptive detail, as shown in FIG. 19A.

Extrinsic sound effects result from what is understood within the contained descriptive detail that occurs under the named source of the sound effects, which source is written in all capital letters and preceded by a series of three opening brackets and followed by a series of three closing brackets, as shown in FIG. 19B, demonstrating how canned laughter is treated.

Music is incorporated into a script notated according to the present invention by adapting conventional music notation without any changes to it. However, two sets of symbols facilitate the adaptation. First, the multiple bracket symbols already demonstrated for extrinsic audio are used to represent extrinsic music (background music). Second, special symbols represent the start and end of a segment of music placed in correlation with other parts of a script. These symbols are M#S and M#E, where M stands for music, S for start, E for end, and # for the actual number corresponding with the numerical occasion of music entries.

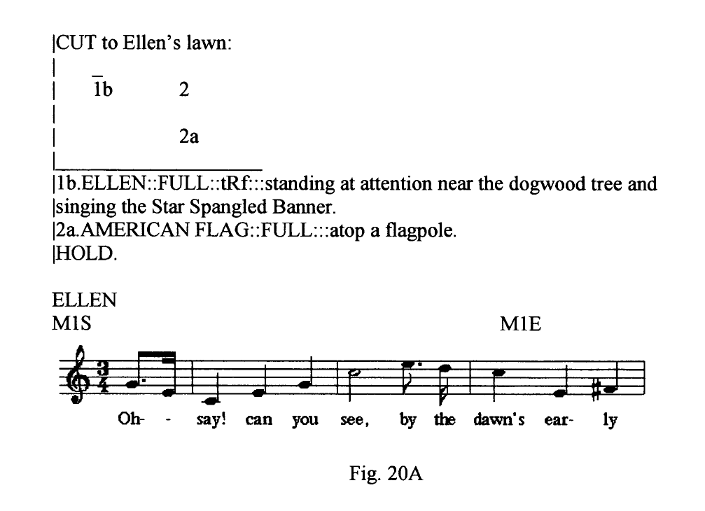

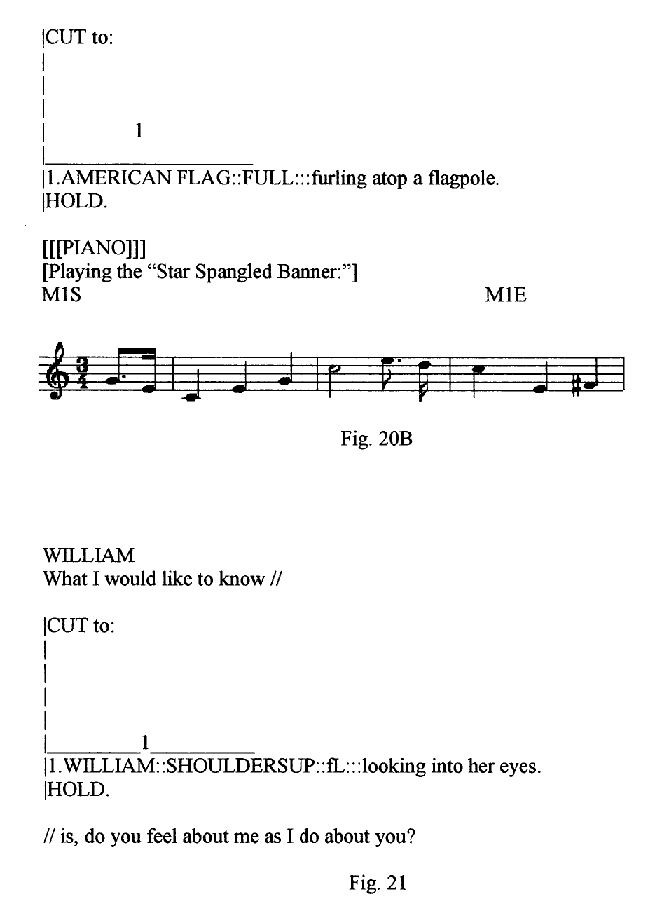

In the application of intrinsic music, as shown in FIG. 20A, the name of the source of the music, in this instance a person singing, is presented in the same manner as the name of a speaker. The start of the music segment is represented by the symbol M#S written below the name and above the music notation, with a left alignment (in this instance: M1S). The end of the music segment is represented by M#E written above the music notation at the end of its entry (in this instance:M1E). If another film notation element (either in the form of a visual note or another audio note) interrupts a musical presentation, then the next segment is indicated by M2S, M2E, etc.

Extrinsic music is written in a manner similar to that used for intrinsic music, except it is introduced in the same way used for extrinsic narration and sound effects. As shown in FIG. 20B, the name of the source of the extrinsic music is written in all capital letters within the triple brackets symbols; the title of the music being performed is written under the name of the source of the music and in the manner of writing contained descriptive detail; and the symbols M#S and M#E are written above the music notation to represent the start and the end of a music segment (in this instance: M1S and M1E).

Regarding continuity of audio notes, if a new visual note (either a staff array or a focal modifier) occurs in the middle of the dialogue or narration of a speaker, the name of the speaker is not repeated after the new visual note; but a double slash is used as a symbol to indicate continuation of the speaker, as shown in FIG. 21. If a new visual note occurs in the middle of speech, the name of the speaker is not repeated. A double slash is placed at the end of the last word of speech before the occurrence of the new visual note, and another double slash is placed before the first word of speech after the occurrence of the visual note. The double slash symbol is placed as just described regardless of whether the point of interruption is at the end of a sentence or in the middle of a sentence. When descriptive detail precedes the continuation of speech after a new staff array, the double slash is placed ahead of the descriptive detail. When the speech of a given speaker carries over a staff array or focal modifier or onto a new page, the name of the speaker may be repeated for ease of reference regarding who is speaking. When this is done, the abbreviation for continued (cont.) follows the name of the speaker and the double slash precedes the speech—or any descriptive detail.

Film notation complements are film notation elements that extend or amend one or more of the elements already presented to facilitate the notation of special filmic circumstances.

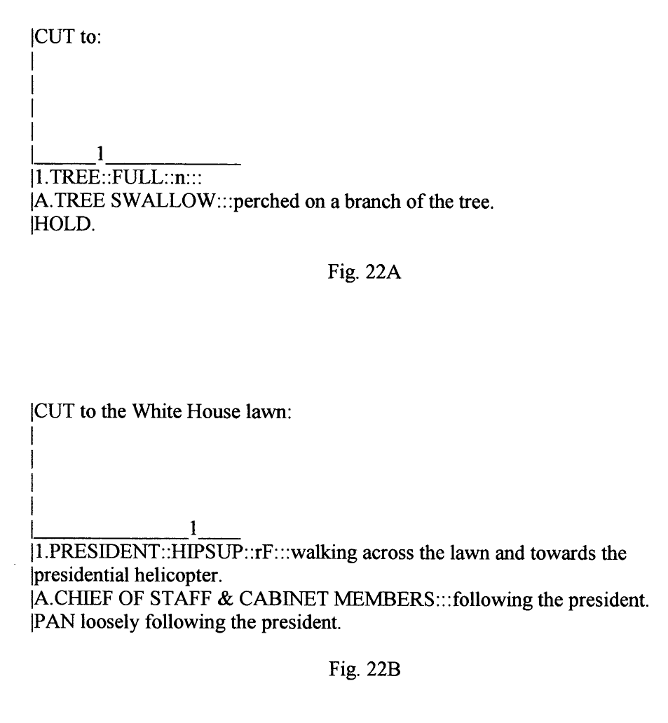

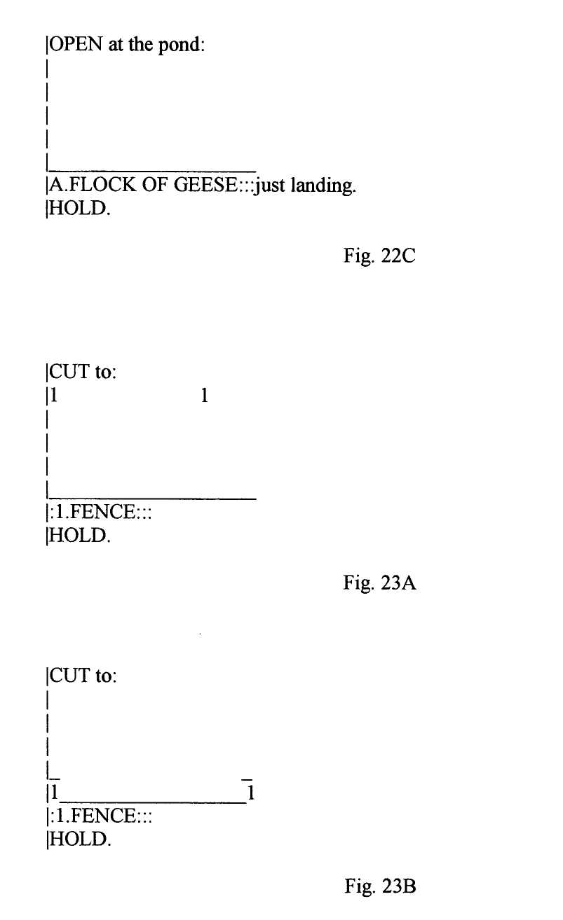

A glimmer is a focal designation that is present in the focal field but for which filmic aspects other than identifying the name of the glimmer are not specified, although contained descriptive detail may accompany it. A glimmer is identified by a glimmer letter. As shown in FIG. 22A, a glimmer is written after the last numbered focal designation. It is identified by a glimmer letter, which is a letter written as a capital letter and beginning with the letter “A” and then “B,” “C,” and so on if more than one glimmer is given. The glimmer letter is written in alignment with the left margin of the staff and other focal designations and it is followed by a period. The name of the glimmer is written in all capital letters and it is followed by a triple colon. A glimmer may include a portion indicator, an angle reference, or contained descriptive detail, but all that is essential is the letter, name, and a triple colon. The letter representing the glimmer is not written in the filmic staff. The actual placement of the glimmer in the focal field is either understood from other information or not significant in itself to advance meaning.

FIG. 22B shows an embodiment in which a glimmer used as a way to simplify the notation of several focal designations—in this instance substituting for distinct designations for the “chief of staff & cabinet members.”

Sometimes situations occur in which meaning in the focal field is advanced merely by use of a glimmer rather than a complete designator, as shown in FIG. 22C. When a glimmer alone is placed under a filmic staff, no designator number is placed in the filmic staff.

A framer is a focal designation that occurs in the focal field so as to frame an edge of the focal enclosure. In the filmic staff, its representation is the same as the representations for focal designations that appear at the edges of the focal enclosure. However, the difference is in the intention to use these focal designations as framers. That intention is indicated by placing a colon in front of the designator number under the filmic staff.

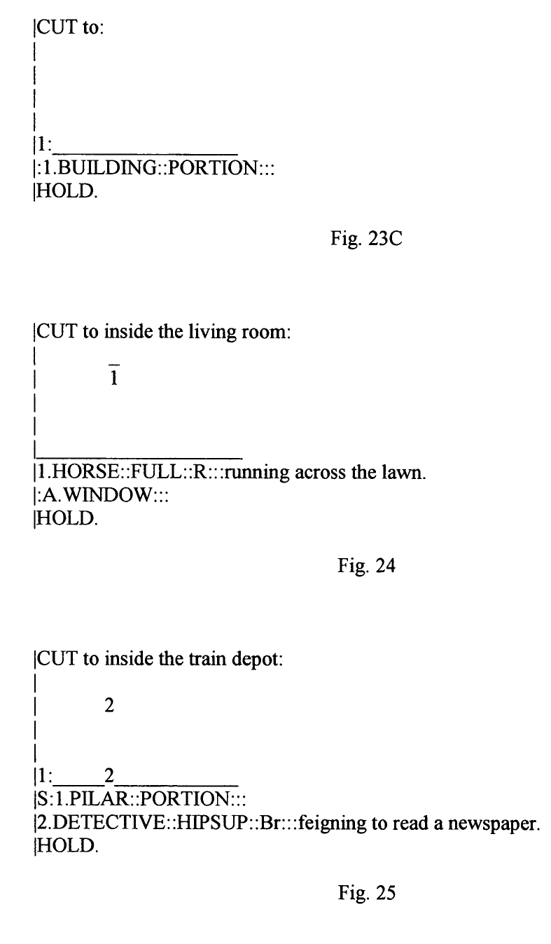

As shown in FIG. 23A, if the framer is framing the top of the focal field, the designator numbers are placed at the top of the filmic staff in the manner already prescribed for focal designations, and a colon is placed in front of the designator number under the filmic staff.

FIG. 23B shows an embodiment in which a focal designation is framing the bottom of a focal enclosure. The designator numbers and vertical limiters are placed at the bottom of the filmic staff in the manner already prescribed for focal designations with vertical limiters, and a colon is placed in front of the designator number under the filmic staff.

FIG. 23C shows an embodiment in which a focal designation is framing a side of a focal enclosure. The designator number and horizontal limiter are placed at the appropriate side of the filmic staff in the manner already prescribed for focal designations with horizontal limiters, and a colon is placed in front of the designator number under the filmic staff.

A full framer is when a single focal designation frames the entire focal enclosure. As shown in FIG. 24, a full framer is represented by placing a colon in front of a glimmer under the filmic staff.

A shadow framer is when a focal designation appears in the edge (or edges) of a focal field so as to blacken or shadow the edge of the focal enclosure. It is represented by using the letter “S” as a symbol and placing it under the filmic staff in front of the colon that indicates a framer when placed in front of a designator number, or a full framer when placed in front of a glimmer letter, as shown in FIG. 25.

A foregrounder is a focal designation that occurs in the focal field so as to appear foremost of all else in, and to extend over all of, or a large portion of the focal enclosure.

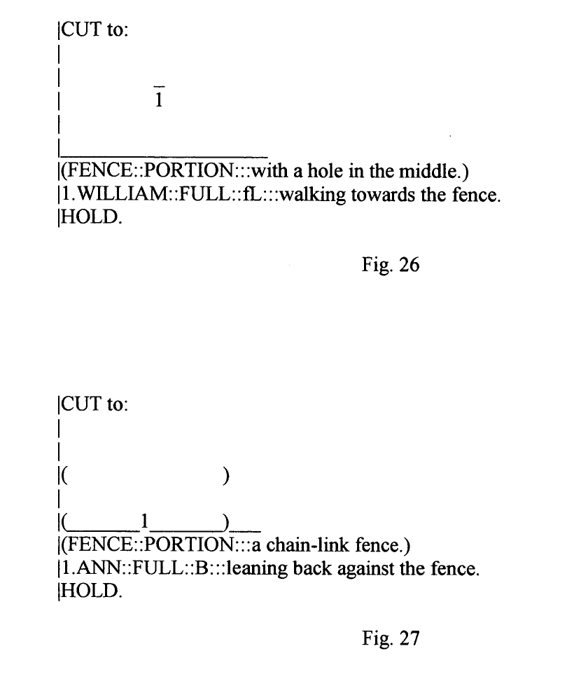

A whole foregrounder occurs when a focal designation appears foremost of all else in, and extends over the entire focal enclosure. As shown in FIG. 26, it is represented by a distinctive use of parentheses under the filmic staff. All foregrounders, including the whole foregrounder, are written under the filmic staff ahead of all other focal designations. They are not preceded by a designator number nor a glimmer letter, but otherwise they are written like any other focal designation, except that they are enclosed in parentheses. A whole foregrounder is not indicated by any reference in the filmic staff, but its presence in the focal field is understood. Thus, in FIG. 26, it is understood that the fence extends across the entire foreground of the focal enclosure and William is behind it and walking towards it.

A partial foregrounder occurs when a focal designation appears foremost of all else in, and extends over only a portion of the focal enclosure. It is represented by a distinctive use of parentheses in and under the filmic staff. As shown in FIG. 27, parentheses are placed in the filmic staff to approximate the location of a partial foregrounder in the focal enclosure. The vertical limit of the partial foregrounder is set by the placement of the parentheses. One parenthesis in vertical placement indicates that the top of the parenthesis approximates the vertical extent of the partial foregrounder. If the vertical extent is more than one parenthesis, then a second—and only a second—parenthesis is placed at the location in the filmic staff approximating the vertical extent (as in FIG. 27). Vertical limiters are not used with foregrounders. The horizontal limit of the partial foregrounder is set by the placement of the parentheses in the filmic staff. Horizontal limiters are not used with foregrounders. Under the filmic staff, a partial foregrounder is notated in the same manner as a whole foregrounder. Thus, the interpretation of FIG. 27 is that the fence extends about two thirds across the lower two thirds of the focal enclosure. Ann is behind the fence and leaning against it.

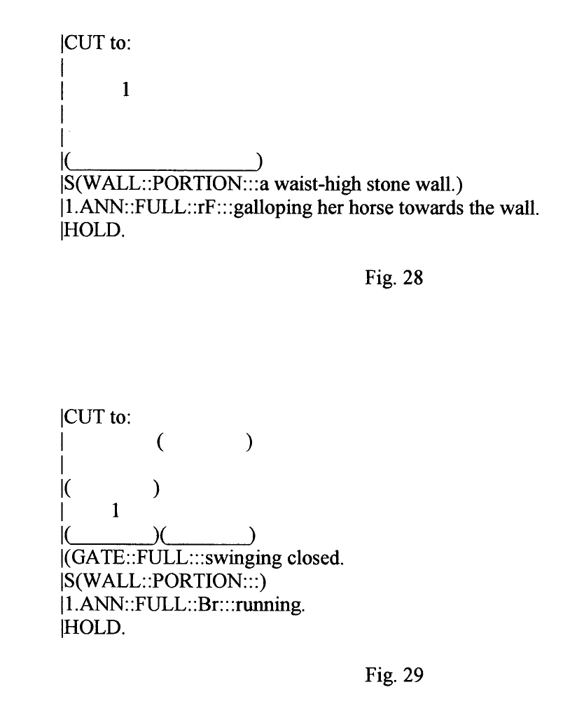

A shadow foregrounder is another way to notate a shadow framer. It occurs when a partial foregrounder effects a shadow foremost of all else in the focal enclosure. As shown in FIG. 28, a shadow foregrounder is notated in the same way as a partial foregrounder, except the symbol S is placed in front of the first parenthesis under the filmic staff. Thus, FIG. 28 is interpreted that the wall extends across and blackens the lower portion of the focal enclosure.

A combined foregrounder occurs when two partial foregrounders or both a partial foregrounder and a shadow foregrounder or similar combinations appear in the focal enclosure together. As shown in FIG. 29, when more than one partial foregrounder occurs in the focal field, the parentheses for each are placed in the filmic staff at approximately the positions they occupy in the focal enclosure. Under the filmic staff, the foregrounders are placed according to their type and the rules already presented for them, beginning with the one that occurs left-most in the filmic staff. Thus, the interpretation for FIG. 29 is that the gate extends halfway across and halfway up the focal enclosure and is just swinging closed; the wall blackens the right half of the focal enclosure; and Ann is running away from the gate.

A backgrounder is a focal designation that occurs in the focal field so as to appear rearmost of all else in, and to extend over all of or a large portion of the focal enclosure.

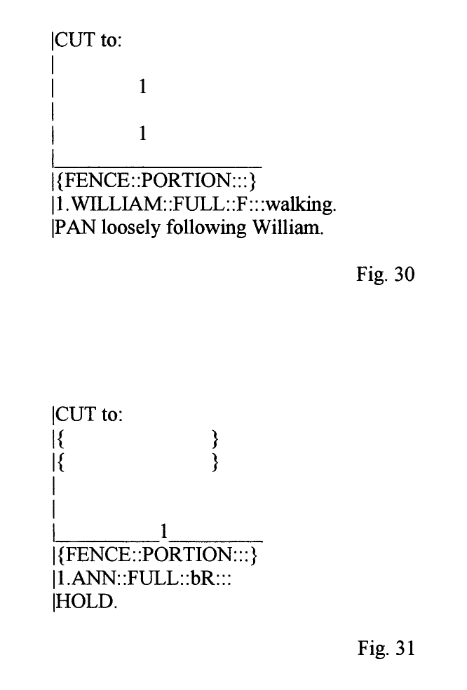

A whole backgrounder occurs when a focal designation appears rearmost of all else in, and extends over the entire focal enclosure. It is represented by enclosure in braces, i.e. { }, as shown in FIG. 30. All backgrounders, including the whole backgrounder, are written under the filmic staff ahead of all other focal designations. They are not preceded by a designator number nor a glimmer letter, but otherwise they are written like any other focal designation. A whole backgrounder is not indicated by any reference in the filmic staff, but its presence in the focal field is understood. Thus, FIG. 30 is interpreted that the fence is rearmost in the focal field and extends across the entire focal enclosure. William is in front of the fence and walking away from it.

A partial backgrounder occurs when a focal designation appears rearmost of all else in, and extends over only a portion of the focal enclosure. It is represented by enclosure in braces, i.e. { }, in and under the filmic staff. As shown in FIG. 31, the symbol { } is placed in the filmic staff to approximate the location of the partial backgrounder in the focal enclosure. The vertical limit of the partial backgrounder is set by the placement of the backgrounder symbols. One symbol in vertical placement indicates that the top of the symbol approximates the vertical extent of the partial backgrounder. If the vertical extent is more than one symbol, then a second—and only a second—symbol is placed at the location approximating the vertical extent (as in in FIG. 31). Vertical limiters are not used with backgrounders. The horizontal limit of the partial backgrounder is set by the placement of the backgrounder symbols in the filmic staff. Horizontal limiters are not used with backgrounders. Under the filmic staff, a partial backgrounder is notated in the same manner as a whole backgrounder. Thus, FIG. 31 is interpreted that the fence extends across most of the upper third of the focal enclosure. Ann is in front of the fence.

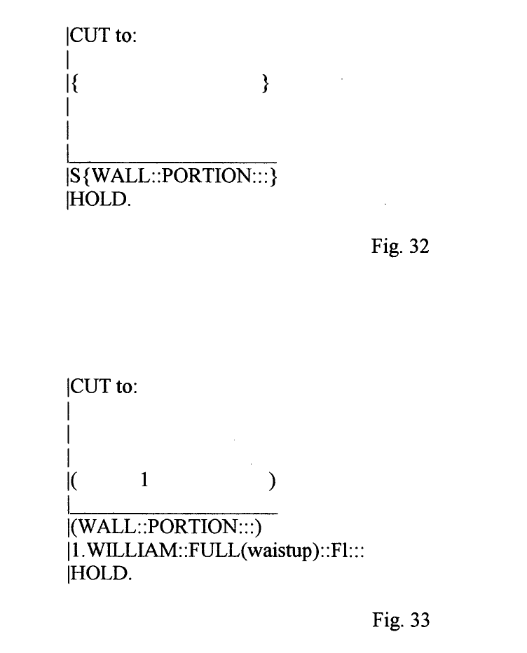

A shadow backgrounder is another way to notate a shadow framer. It occurs when a partial backgrounder effects a shadow rearmost in the focal enclosure. As shown in FIG. 32, a shadow backgrounder is notated in the same way as a partial backgrounder, except the symbol S is placed in front of the first { symbol, i.e., brace, under the filmic staff. Thus, FIG. 32 is interpreted that the wall extends across and blackens the upper middle portion of the focal enclosure.

The portion indicator always relates the focal designation to the whole focal field, even when someone or something in the focal field obscures part of the focal designation. The portion indicator qualifier (a contained aspect that functions as a filmic aspect) is used to reference the portion of the focal designation actually visible behind whatever obscures it. As shown in FIG. 33, the portion indicator qualifier is written in all lower case letters within parentheses, following the portion indicator, and without any space between it and the portion indicator, on the left, or the double colon, on the right. The portion indicator qualifier uses brief descriptive detail to indicate what is actually visible. Thus, FIG. 33 is interpreted that William is fully in the focal field, but he is behind the wall and visible only from the waist up.

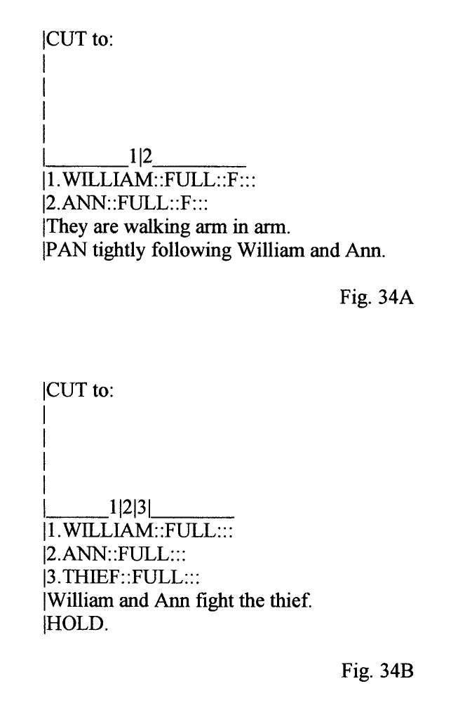

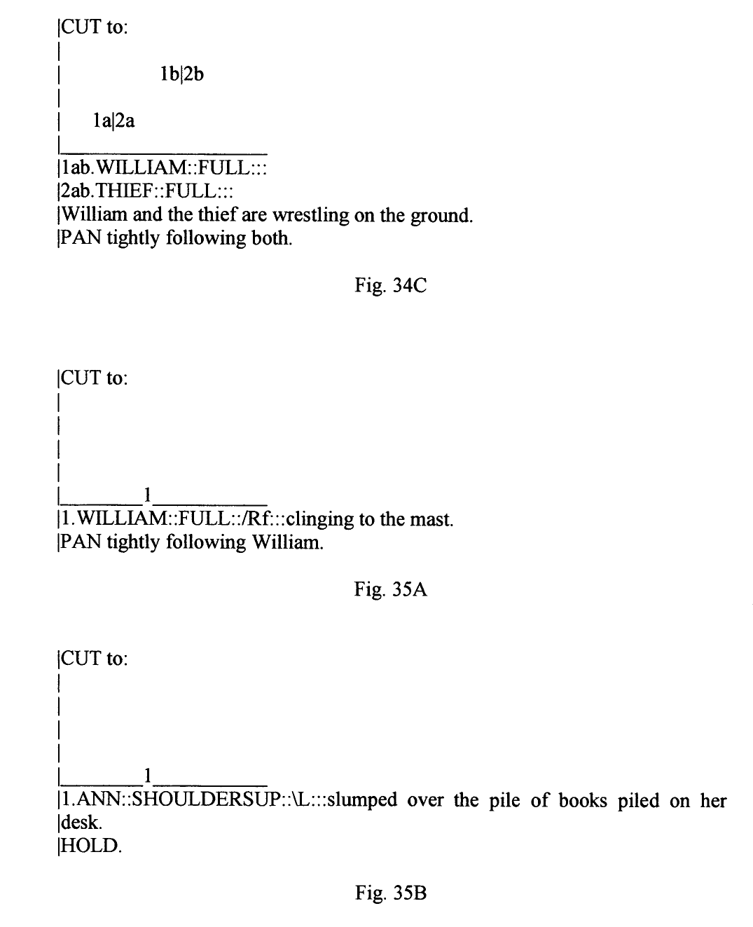

An entangler references two or more focal designations when they are tangent or entangled. The symbol | (an upright virgule) references such situations. A first embodiment of this application is shown in FIG. 34A, in which an upright virgule, |, is placed between two designator numbers in the filmic staff to indicate focal designations that are tangent. In a second embodiment of the entangler application, as shown in FIG. 34B, upright virgules separate three focal designations to indicate focal designations that are entangled. When two focal designations are entangled and require representation as if they are enveloped in a noncubical rectangular box, the entangler symbol in a third embodiment, is placed between both sets of designator numbers and depth reference letters in the filmic staff, as shown in FIG. 34C.

The imaginary cubical form, as already mentioned, envelops the focal designation in a fluid rather than a rigid manner. However, the axis of the imaginary cubical form is generally assumed as upright. Angle reference qualifiers are symbols to indicate a different axis. The symbol / (a virgule) is used to indicate a right-leaning axis, and the symbol \ (a reverse virgule) is used to indicate a left leaning axis.

FIG. 35A shows an embodiment in which a virgule is written before the angle reference letters under the filmic staff to indicate a right-leaning axis for the focal designation. Thus, the interpretation for FIG. 35A is that William is at a right-leaning axis to the base of the focal enclosure. In a second embodiment of this application, as shown in FIG. 35B, a reverse virgule is written before the angle reference letters to indicate a left-leaning axis for the focal designation. Thus, the interpretation for FIG. 35B is that Ann is at a left-leaning angle to the base of the focal enclosure. However, leaving out the angle reference altogether is an acceptable abridgement when, because of circumstances such as concurrent action, the angle is too ill-defined to advance meaning itself

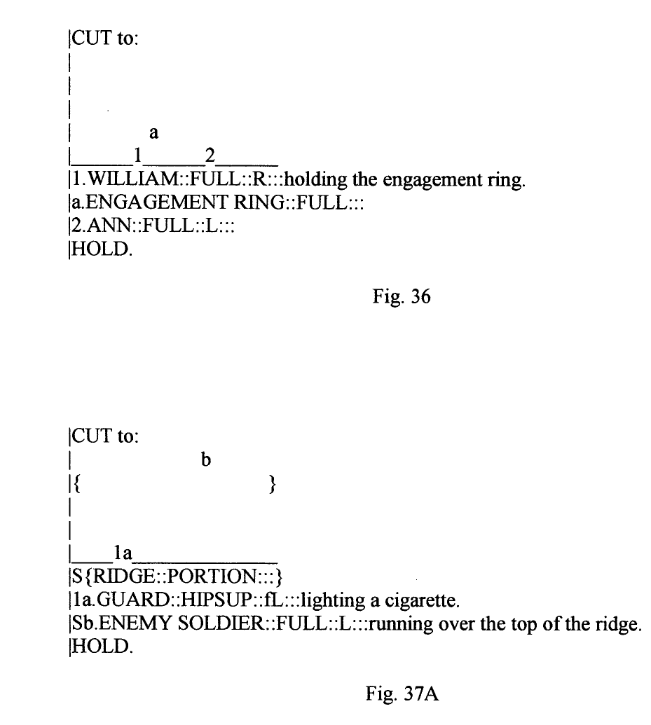

A smalliff (small in focal field) is a focal designation that occurs in the focal field so as to appear very small, occupying a very small portion of the focal enclosure. It is represented by smalliff letters, which are lower case letters placed both in the filmic staff, in the approximate location of the smalliff in the focal enclosure, and under the filmic staff, as shown in FIG. 36, a first embodiment of this application. The lower case letters in smalliff applications serve simultaneously as smalliff letters and depth reference letters. The spacial limits of the smalliff letter itself in the filmic staff approximates the actual limits of the smalliff in the focal field, allowing little interpretation to spacial expansion. The smalliff letter is written under the filmic staff in the same order as designator numbers: the left-to-right and, then, top-to-down order in the filmic staff converts to top-to-down under the filmic staff. The smalliff letter under the filmic staff is followed by a period, without a space between it and the period, then the designator name, a portion indicator, angle reference, and descriptive detail, as required by the situation. As mentioned above, the smalliff letter is simultaneously its own depth reference letter; in regards to its depth reference, the smalliff corresponds to the order of depth in relation to other focal designations in the focal field. Thus, the interpretation for FIG. 36 is William and Ann are at the same depth and, therefore, do not need depth reference letters. William's holding the ring gives the ring the same depth as William, which is why the smalliff is represented by the smalliff letter “a.”

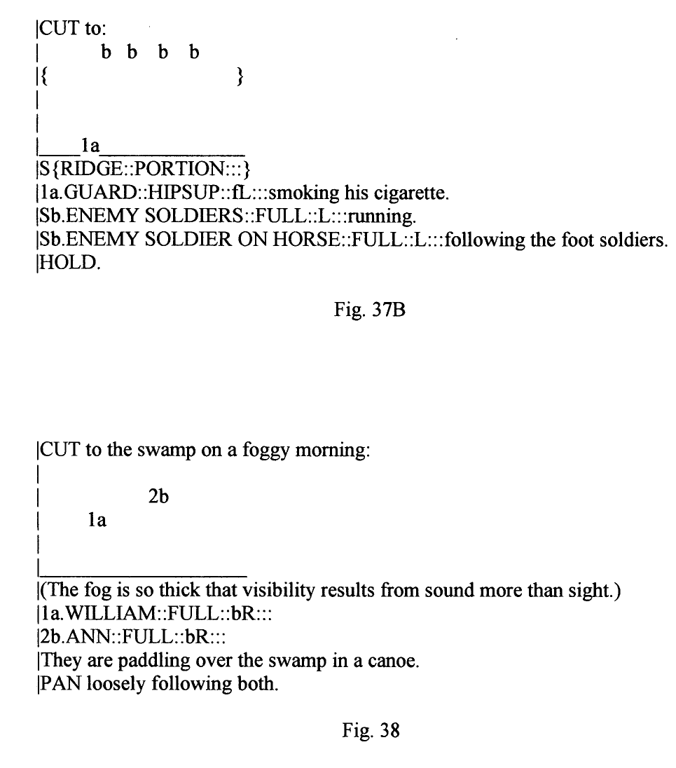

A shadow smalliff occurs when a smalliff is silhouetted in the focal field. When a shadow smalliff occurs, its smalliff letter under the staff is preceded by the shadow symbol S, as shown in FIG. 37A, in which the interpretation is that the enemy soldier appears as a very small shadow running over the ridge in the far background.

When more than one smalliff occurs in a focal field at the same depth relationship as another smalliff, each is represented by the same depth reference letter. As shown in FIG. 37B, each smalliff letter represents a distinct focal designation. More than one smalliff letter is never used for a given focal designation. If more than one smalliff is in the same depth relationship as another, each is represented by the same smalliff letter in the staff and under the staff; however, each may have a distinct line under the staff. Thus, the interpretation for FIG. 37B is that enemy soldiers on foot are running across the ridge followed by a soldier on horseback. All appear as very small shadows in the far background.

A general filmic qualifier is contained descriptive detail that can be used to clarify any filmic element or several elements or all—in a general manner. Such clarifications about filmic elements are presented within parentheses under the filmic staff with the distinctive placement of being the first entry under the filmic staff, as shown in FIG. 38.

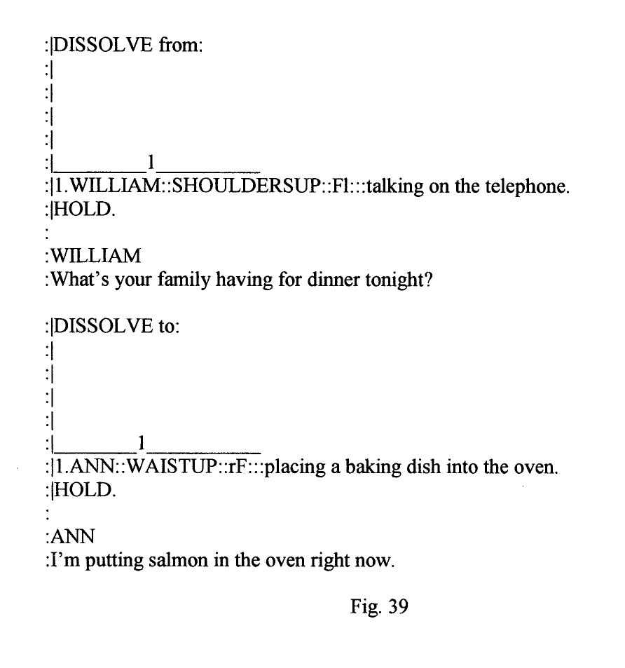

A dissolve results from the editing technique that lays a fading-in filmic presentation over a fading-out presentation. In the present invention, each presentation is distinctly notated. FIG. 39 shows this embodiment for the present invention. A dotted vertical bar (which may consist of colons running vertically) precedes the standard vertical bar of the visual note and continues on through the audio note, extending from the beginning of the fading-in presentation to the end of the fading-out presentation. The filmic coordinate and coordinate auxiliary “DISSOLVE from” form the lead-in coordinate for the fading-out presentation. The filmic coordinate and coordinate auxiliary “DISSOLVE to” form the lead-out coordinate for the fading-in presentation.

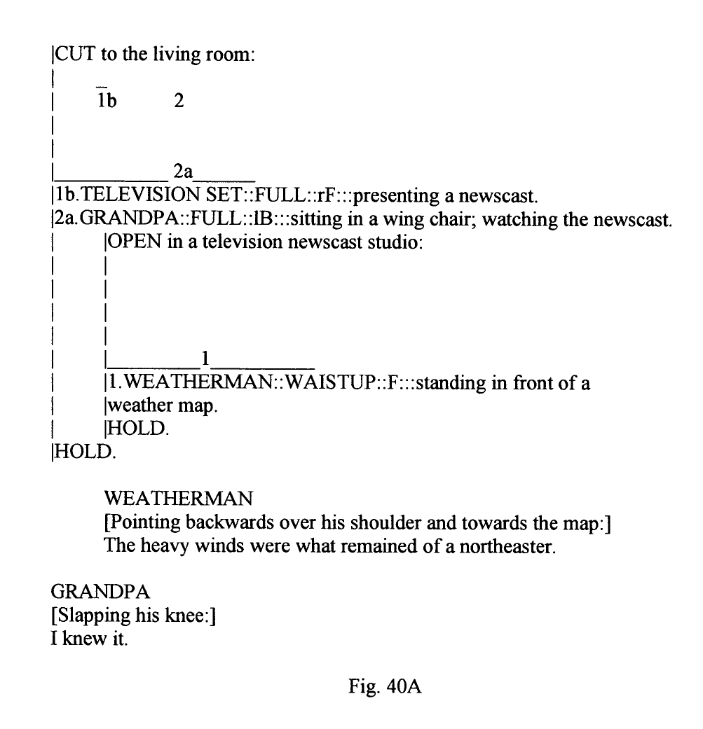

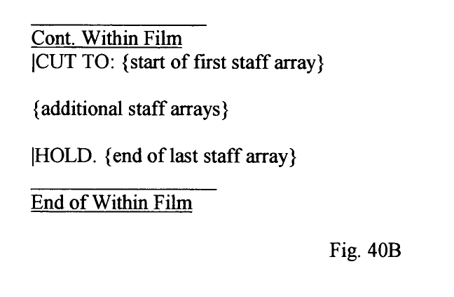

A presentation of film within a film, such as a film being presented on a television screen that is placed within a focal field, is called a within film. It is notated in the same manner as prescribed for the main film itself, except that it receives a distinctive graphic presentation. As shown in FIG. 40A, a within film is notated just like the main film, except it is indented. The visual note of a within film is written immediately after the last indicator line or the last line of a contained descriptive detail extension. The vertical bar continues for the notation of the main film's visual note throughout the presentation of the within film's visual note, which carries its own vertical bar. After the notation of the information pertaining to the within film's visual note is presented, the filmic coordinate for the main film's visual note is written. The audio note for the within film also is notated just like the audio note for the main film, except it is indented. The sequence for the presentation of the within film's audio notes and the main film's audio notes follows the order of occurrence. If the occurrence is simultaneous, the within film's audio note precedes the main film's.

If a presentation of within film is extensive while no change occurs in the main film, the within film may be represented as if it were the main film with the addition that its first staff array is preceded by a double horizontal bar that encloses the phrase “Cont. Within Film,” and its last staff array is followed by another double horizontal bar that encloses the phrase “End Within Film,” as shown in FIG. 40B.

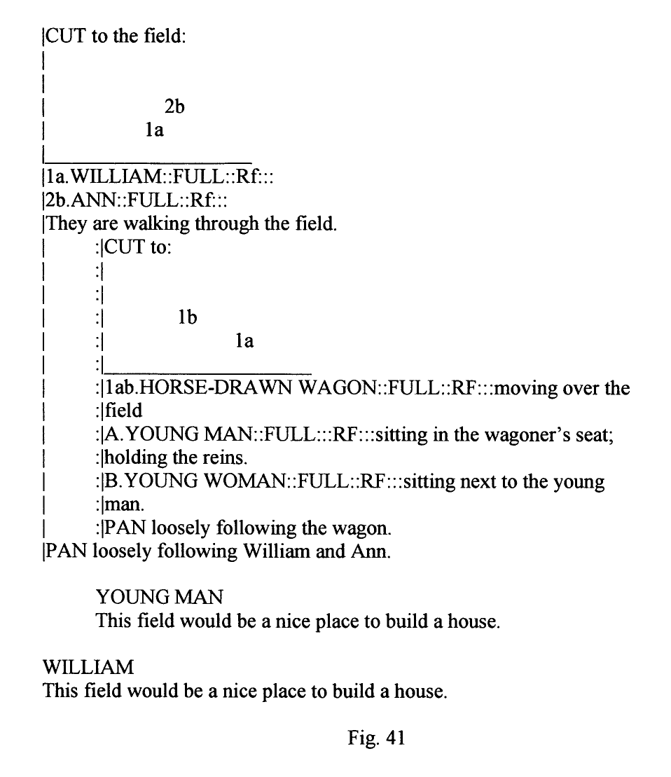

A presentation of film over a film, such as film occurring in a transparency overlaid on a main film, is called film over. It is notated in the same manner as within film, except it has a distinctive graphic presentation of its own, as shown in FIG. 41, wherein the vertical bar is preceded by a dotted vertical bar (which may consist of colons running vertically).

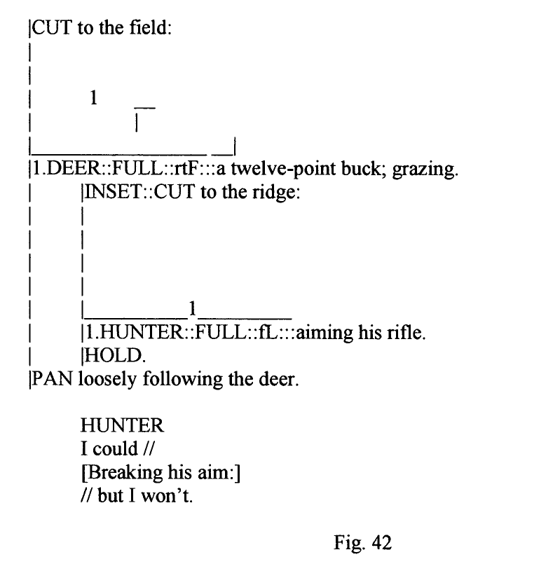

When a segment of the focal enclosure is used to display a film presentation distinct from the presentation in the rest of the focal enclosure, the film occurring in the segment is called an inset film. As shown in FIG. 42, the location of the inset film is indicated in the main focal enclosure by placing corner lines in the filmic staff approximating the location. Only short lines are used, one vertical and one horizontal, to suggest the upper left corner and the opposite lower right corner. The inset film itself is notated like the main film, except it is indented in the same manner as within film and the word “INSET,” followed by a colon precedes the lead-in coordinate.

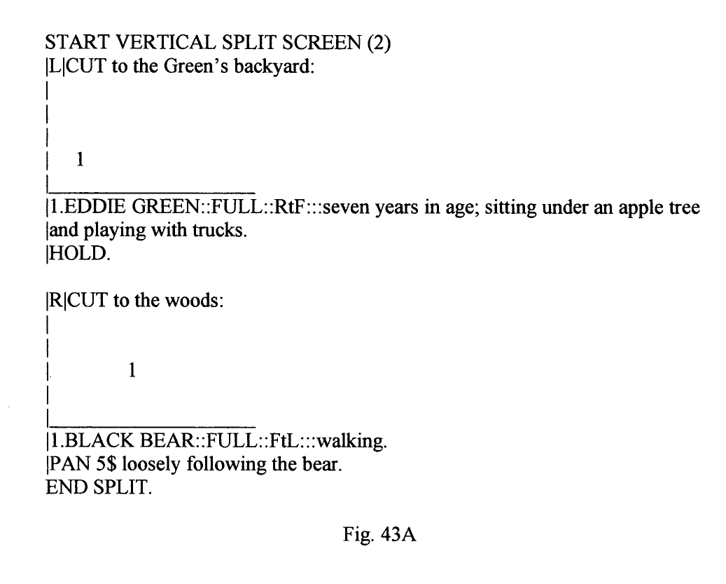

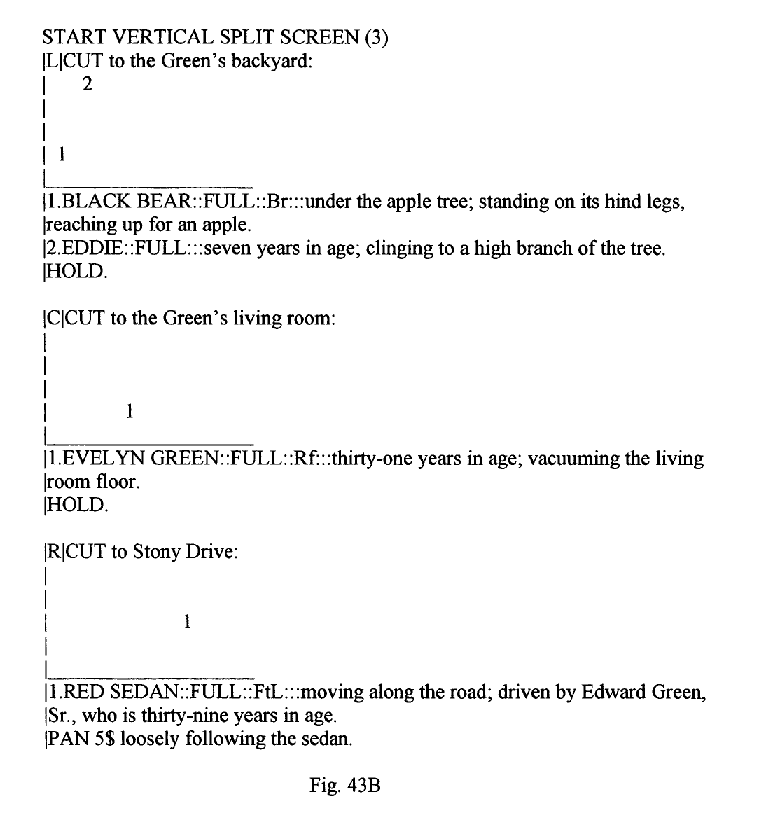

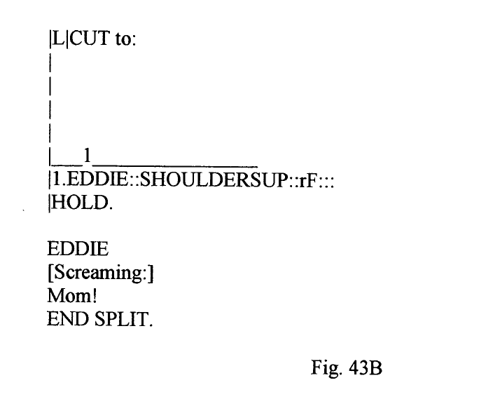

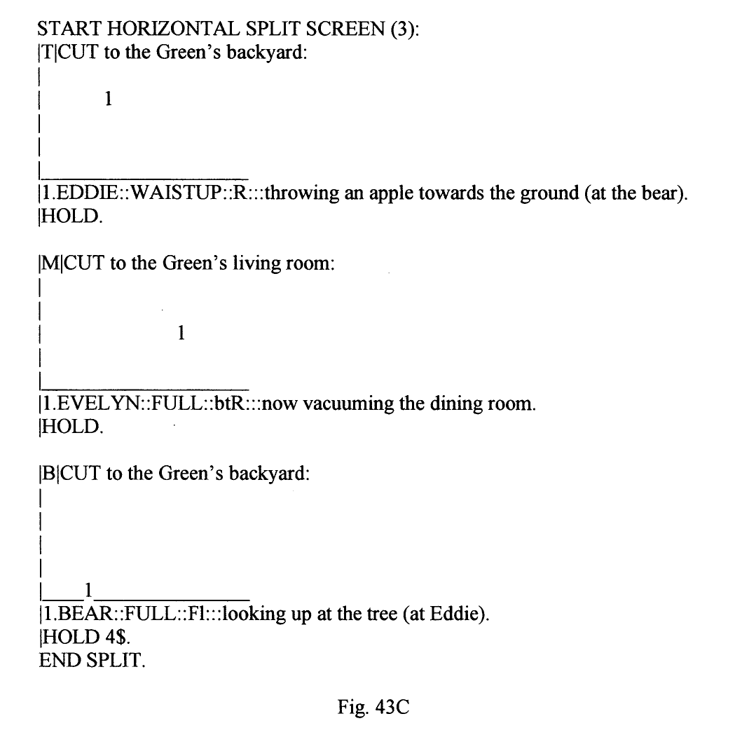

When the focal enclosure is divided into two or three parts, with each part displaying its own filmic content simultaneously to the other part or parts, the effect is called a split screen. FIG. 43A, FIG. 43B, and FIG. 43C show three embodiments of a split screen. The beginning of a split screen is indicated by the words START VERTICAL SPLIT SCREEN (as in FIG. 43A and FIG. 43B) or START HORIZONTAL SPLIT SCREEN (as in FIG. 43C), with the words written in all capital letters. The number of screens (i.e., focal enclosures) in the split is given in parenthesis. The parenthesis is followed by a colon. Each lead-in coordinate is preceded with a letter to indicate which screen is being presented in the staff array. For vertical split screens, the letters may be L (for left screen), C (for center screen), and R (for right screen). For horizontal split screens, the letters may be T (for top screen), M (for middle screen), and B (for bottom screen). These letters are preceded by a vertical bar and followed by a vertical bar. The duration of a set of split screens is either indicated by the filmic content or by a time indicator included in the lead-out coordinate for the last screen in the set. Change in one of the screens may be presented without repeating the staff arrays for the other screens (as in FIG. 43B, where there is a change only in the last staff array). Dialogue is presented in the regular manner, occurring after its corresponding staff array or after all the staff arrays in a given split. The end of a split screen is indicated by the words END SPLIT written in all capital letters and followed by a period. These words may appear after the last staff array in a given split (as in FIG. 43A and FIG. 43B), or after the last dialogue entry (as in FIG. 43C).

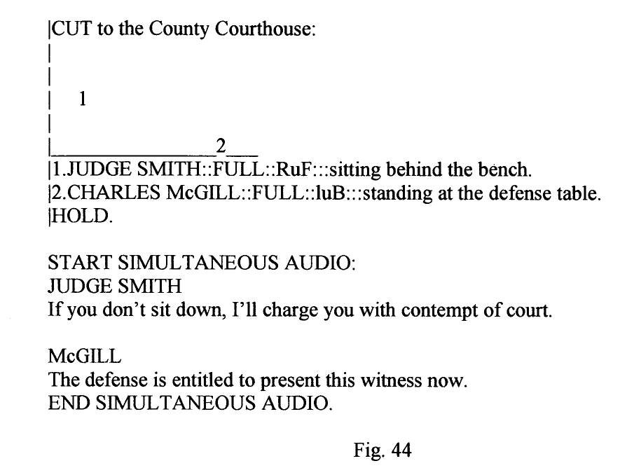

Instances of audio often occur simultaneously. Most of these instances can be understood as being simultaneous from the context of the filmic content, such as when a person on a crowded bus is talking to the person next to him while others are also engaged in conversations. Other instances must be specifically indicated as being simultaneous, and these are called simultaneous audio. As shown in FIG. 44, an instance of simultaneous audio requiring specific indication it is such is preceded by the words START SIMULTANEOUS AUDIO, written in all capital letters and ending with a colon; and followed by the words END SIMULTANEOUS AUDIO, also written in all capital letters.

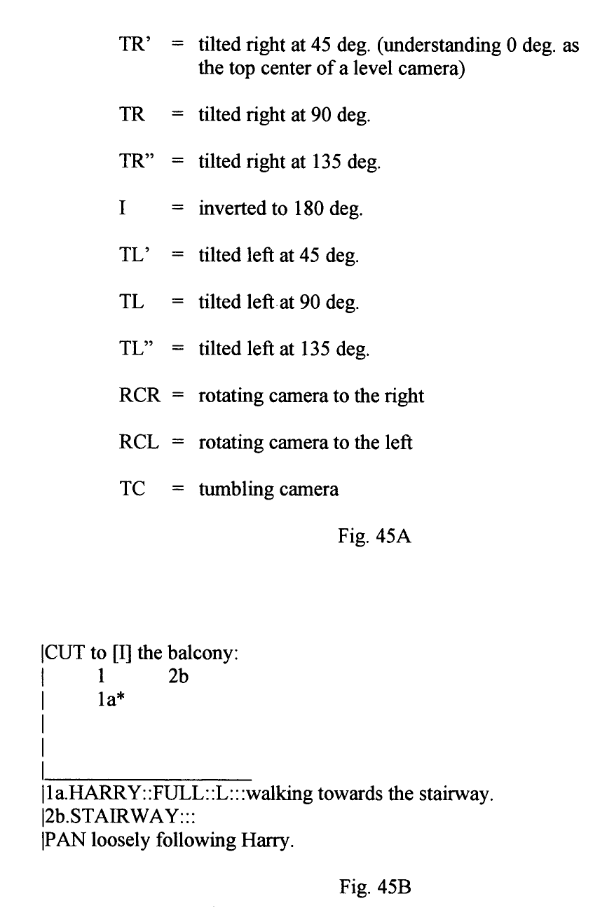

The screen is always at a level orientation, with its bottom understood as parallel with the plane of the horizon. The presentation on the screen, however, can give the effect of an off-level camera. These camera effects are represented by the symbols (combinations of letters or letters plus punctuation) illustrated in FIG. 45A. An embodiment of these off-level camera symbols is shown in FIG. 45B. The off-level camera symbol is written within brackets immediately after the coordinate auxiliary of a lead-in coordinate. The top of a focal designation is indicated by an asterisk. Thus, FIG. 45B is interpreted that the visual content is presented as if the screen is inverted. Harry is walking towards the stairway and is nearer than the stairway.

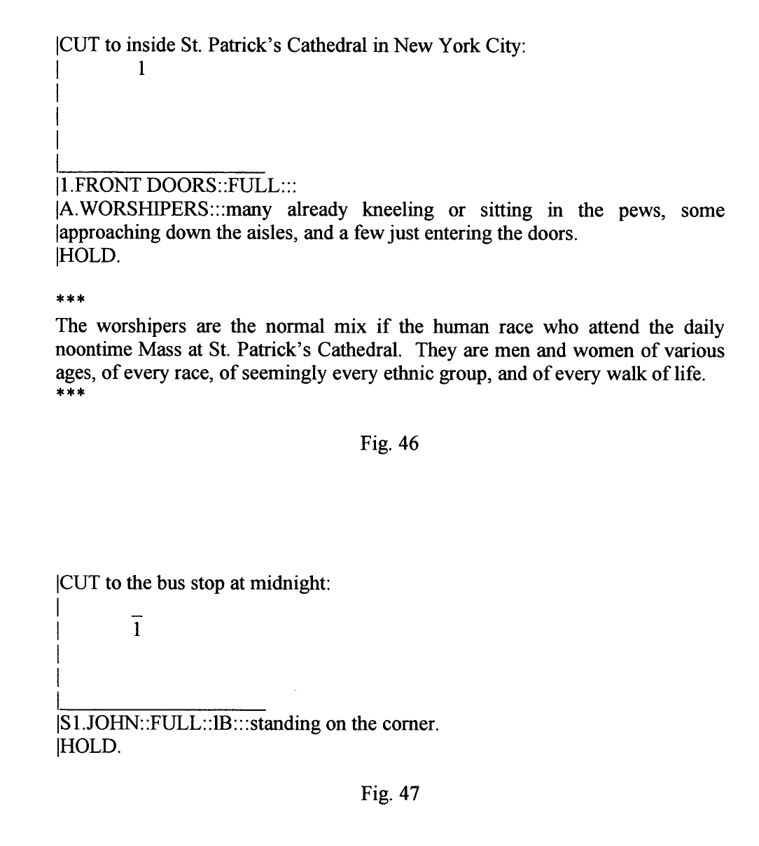

The author of a notated film script may include comments extraneous to the script's content, placing these where he thinks they are appropriate to enhance what is presented in the script. FIG. 46 shows that in such an application an author's comments are set off by three asterisks beginning at the left margin on the line before the comments and again beginning at the left margin on the line after the comments.

Any focal designation that appears in the focal field as if in a shadow, though not as a shadow framer, is thus indicated by placing the shadow symbol, S, before the designator number, glimmer letter, or smalliff letter, as shown in FIG. 47.

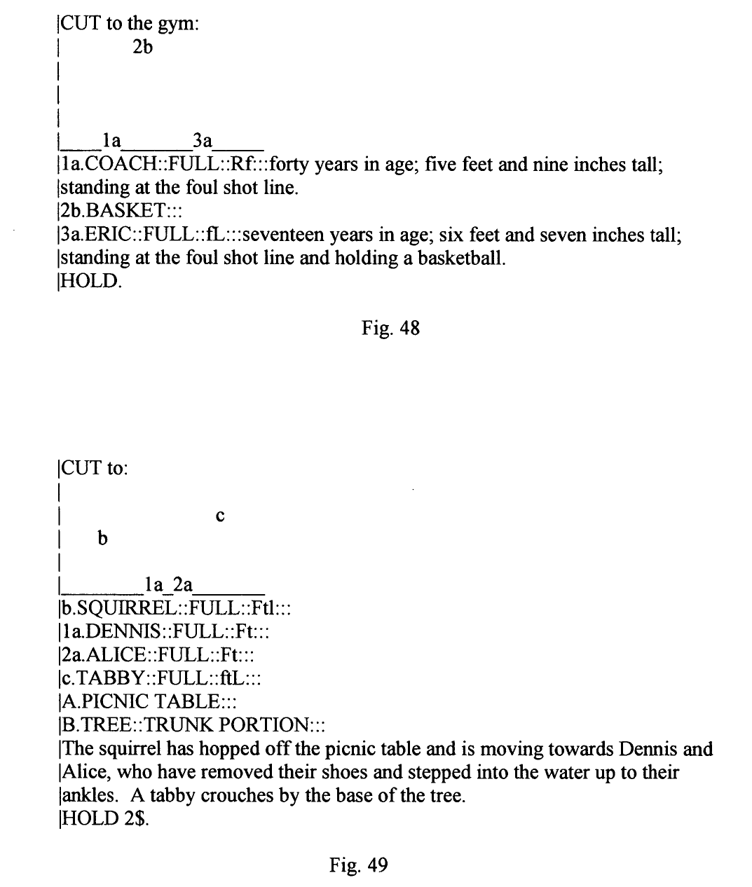

Focal designations that are people of different height appearing in the same focal field need not be specifically notated to indicate the difference in their vertical relationship in the focal enclosure. The difference may be assumed from the contained descriptive detail, as shown in FIG. 48, where the interpretation is obvious that a six-feet-and-seven-inches tall person is taller than a five-feet-and-nine-inches tall person.

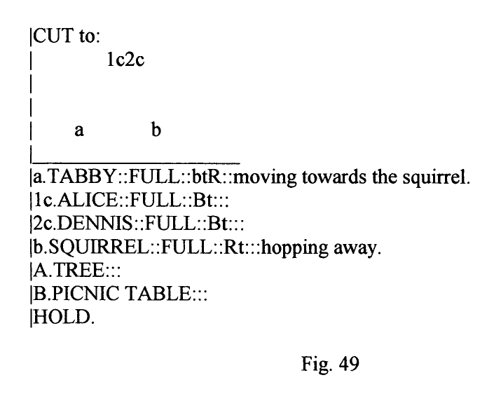

Each staff array presents a focal field anew regarding the assigning of designator numbers, glimmer letters, and smalliff letters. Thus, these attributions do not influence continuity from one staff array to the next, as shown in FIG. 49.

Implementation of the cube method of film notation should be done with succinctness and an understanding that any of the elements can be abridged to satisfy succinctness so long as the abridgement does not compromise comprehensiveness. However, an attempt should be made to assign a designator number and name before opting, for example, for a glimmer.

Finally, all the notational elements in the cube method of film notation should be applied with a sense of fluidity, not rigidity.

What is claimed is:

1. A method for composing any motion picture script, said method comprising:
distinguishinging visual notes from audio notes by placing a vertical bar alongside all said visual notes;
representing filmic coordinates and coordinate auxiliaries of said visual notes by distinctive formations and distinctive placements of standard words at the head and foot of said visual notes;
representing the focal place elements of the focal field of said visual notes by a distinctive placement of standard words at the head of said visual notes;
representing the focal enclosure of said visual notes by a filmic staff;
representing said filmic staff by a simplified filmic staff;
representing the designatators in the filmic aspects of the focal designation elements of said focal field by the combination of numerals and distinctive formations of standard words placed under said filmic staffs and followed by distinctive punctuation symbols;
representing the portion indicators of said filmic aspects by distinctive formations of standard words placed after said punctuation symbols of said designators and followed by distinctive punctuation symbols;
representing the angle references of the placement indicators of said filmic aspects by combinations of letters of the alphabet placed after said punctuation symbols of said portion indicators and followed by distinctive punctuation symbols;
representing the plane references of said placement indicators by placing said designator numerals within said filmic staff;
representing the depth references of said placement indicators by placing letters of the alphabet next to their corresponding designator numerals under the filmic staff and within the filmic staff;
representing the contained media aspects of said focal designation elements by standard word usage placed after said punctuation symbols that follow said angle references; and
representing the duration of certain coordinates at the foot of said visual notes by a time symbol.

2. The method of claim 1, comprising:
audio notes represented by standard word usage and standard musical notation usage distinctively placed after correlating said visual notes;
and continuity of audio notes represented by a distinctive placement of distinctive symbols.

3. The method of claim 1, comprising:
an abridgement of said designator eliminates an angle reference or an angle reference plus portion indicator yet has the designator followed by said punctuation symbols that normally follow said angle reference;
an abridgement of said visual note eliminates a concluding filmic coordinate and substitutes for it an end bar;
a modification of said filmic coordinate or said contained media aspects is represented by a said filmic coordinate and/or said contained media aspects distinctively places unattached to a filmic staff,
a glimmer version of said focal designator is represented by substituting a capitalized letter of the alphabet for the numeral preceding said designator name while excluding said capitalized letter from within the filmic staff;
a framer of said focal field by said focal designation is represented by preceding said designator numeral under said filmic staff with a distinctive punctuation symbol;
a full framer of said focal field by said glimmer is represented by preceding said glimmer letter under said filmic staff with a distinctive punctuation symbol;
a shadow framer of said focal field by said focal designation is represented by preceding said distinctive punctuation symbol that precedes said designator number under said filmic staff with a distinctive letter of the alphabet and attaching the same distinctive punctuation to the same designator number within said filmic staff;
a shadow framer of said focal field by said glimmer is represented by preceding said distinctive punctuation symbol that precedes said glimmer letter under said filmic staff with a distinctive letter of the alphabet without any additional entry within said filmic staff;
a whole foregrounder of said focal field is represented by enclosing said glimmer name, portion indicator, and any contained media aspects within distinctive punctuation symbols under said filmic staff;
a partial foregrounder of said focal field is represented by adding distinctive punctuation symbols within said filmic staff;
a shadow foregrounder of said focal field is represented by a distinctive placement of a distinctive letter under said filmic staff;
a whole backgrounder of said focal field is represented by a distinctive placement of distinctive punctuation symbols under said filmic staff;
a partial backgrounder of said focal field is represented by a distinctive placement of distinctive punctuation symbols within said filmic staff;
a shadow backgrounder of said focal field is represented by a distinctive placement of a distinctive letter of the alphabet under said filmic staff;
a portion indicator qualifier of said portion indicator is represented by a distinctive placement of standard word forms within distinctive punctuation symbols immediately following said portion indicator;
an entangler is represented by a distinctive placement of a distinctive punctuation symbol within said filmic staff;
an angle reference qualifier is represented by a distinctive placement of one of various distinctive punctuation symbols under said filmic staff;
a smalliff is represented under said filmic staff by a distinctive letter of the alphabet along with an indicator name or an indicator name and a portion indicator or an indicator name, portion indicator, and angle reference and represented within said filmic staff by a distinctive placement of the same said letter of the alphabet;
a shadow smalliff is represented by a distinctive placement of a distinctive letter of the alphabet under said filmic staff;
a general filmic qualifier is represented by a distinctive placement of standard word usage within distinctive punctuation symbols under said filmic staff;
a dissolve is represented by distinctive punctuation symbols placed alongside the vertical bar;
a within film is represented by a distinctive placement of simultaneous visual notes and audio notes;
a film over is represented by a distinctive placement of distinctive punctuation symbols alongside the vertical bar of one of two simultaneous visual notes;
an inset film is represented by a distinctive placement of distinctive symbols within said filmic staff;
a split screen is represented by distinctive placements of distinctive word formations;
simultaneous audio is represented by distinctive placements of distinctive word formations;
an off-level camera is represented by a distinctive placement of distinctive letters of the alphabet and distinctive punctuation symbols; and
the entire foregoing system of motion picture notation that uses standard data entry characters for symbols and formations, standard words for distinctive formations and distinctive placements, and standard word usage for distinctive placements—all to compose in a script the visual notes and audio notes that represent the cinguistic elements in any motion picture.
